(19) United States
(12) Patent Application Publication
(10) Pub. No.: US 2026/0222490 A1
(43) Pub. Date: Jul. 30, 2026

(54) ASSESSING AND IMPROVING CONTACT CENTER PERFORMANCE

(71) Applicant: Afiniti AI Limited, Dublin (IE)

(72) Inventor: Edmund Blair ROBINSON, Hamilton (BM)

(73) Assignee: Afiniti AI Limited, Dublin (IE)

(21) Appl. No.: 19/141,464

(22) PCT Filed: Dec. 22, 2023
(86) PCT No.: PCT/US2023/085786

§ 371 Date: Jun. 20, 2025

Related U.S. Application Data
(60) Provisional application No. 63/435,029, filed on Dec. 23, 2022.

(51) Int. Cl. H04M 3/523; H04M 3/51

(52) U.S. Cl. CPC H04M 3/5232; H04M 3/5175

(57) ABSTRACT

Methods, systems, and apparatus, including computer programs encoded on computer-storage media, for assessing and improving contact center performance. In some implementations, a system obtains historical data for a contact center system and identifies a threshold level of reliability for evaluating pairing strategies for the contact center system. Based on the historical data, the system determines a region of a parameter space, where the region represents combinations of parameter values for which performance improvements due to using a second pairing strategy with a first pairing strategy are identifiable with at least the threshold level of reliability. The system selects a usage rate for the second pairing strategy based on the determined region and performs pairing of contacts and agents with a usage rate of the second pairing strategy based on the selected usage rate.

### CROSS-REFERENCE TO RELATED APPLICATIONS

This application claims the benefit of U.S. Provisional Patent Application No. 63/435,029, filed on Dec. 23, 2022, the entirety of which is incorporated by reference herein.

### BACKGROUND

There are many scenarios where a task needs to be assigned to an agent. For example, when a customer calls a customer service center of an airline company to request a refund for the customer's airline ticket, an agent of the airline company may need to be assigned to the call to handle the customer's request. In selecting an agent to be paired with the call, a pairing strategy may be used.

Examples of the pairing strategy that can be used for pairing the customer's call with an agent include a “first-in, first-out” (FIFO) strategy, a performance-based routing (PBR) strategy, and a behavioral pairing (BP) strategy. The fundamental principles of FIFO strategy, PBR strategy, and BP strategy are known in the field, and thus detailed explanation about the strategies is not provided in this disclosure. Note that there are various types of the BP strategy, and information about the different types of the BP strategy are provided, for example, in U.S. Pat. Nos. 9,300,802, 9,781,269, 9,787,841, 9,930,180, and 10,757,262 all of which are hereby incorporated by reference herein.

Using an appropriate pairing strategy for pairing tasks (e.g., customers'calls) with agents is important not only for efficient usage of agents and contact center computing resources but also for customer satisfaction. For example, in a scenario where customers #1 and #2 are waiting to talk to agents, and agents #1 and #2 are currently available, if customer #1 contacted the customer center before customer #2 contacted the customer center, and if agent #1 became available before agent #2 became available, under FIFO strategy, customer #1 will be paired with agent #1, and customer #2 will be paired with agent #2. However, if the purpose of customer #1's call is to ask questions about purchasing a particular product and agent #2 (but not agent #1) is a sales specialist for the particular product, it is better to pair customer #1 with agent #2 instead of agent #1. Thus, in this scenario, FIFO was not the optimal strategy to use for the pairing.

As explained above, using an appropriate pairing strategy for pairing tasks with agents is important not only for efficient usage of agents and contact center resources but also for customer satisfaction, and there are service provider(s) providing to those companies of the agents (e.g., the airline company) improved pairing strategies for pairing agents with tasks. Note that, in this disclosure, those companies (e.g., the airline company in the example provided above) to which pairing strategies are provided by the service providers are referred as enterprise clients.

There are different types of pairing strategies. For example, a first type of pairing strategy (e.g., such as FIFO strategy) is configured to pair a task with an agent as soon as the task and the agent become available, and such first pairing strategy may be preconfigured at and/or a default pairing strategy of the enterprise client. On the contrary, a second type of pairing strategy (e.g., such as BP strategy) may be configured to wait until more tasks and/or more agents become available, expecting that better suited agents for the currently available tasks (than the currently available agents) would become available later, and/or the second type of pairing strategy may be configured to pair tasks and agents in out-of-sequence orderings.

In some examples where the service provider's pairing strategy is of the second type (e.g., BP strategy) and an enterprise client decides to use the service provider's pairing strategy, the enterprise client may decide to use the service provider's pairing strategy in conjunction with its preconfigured pairing strategy. The enterprise client may rely on the service provider to determine a usage percentage for the service provider's pairing strategy and the enterprise client's pairing strategy.

### SUMMARY

Techniques for assessing and improving the performance of contact center systems are disclosed. A contact center system may perform pairing to assign agents to inbound or outbound contacts (e.g., telephone calls, Internet chat sessions, email). The contact center system can algorithmically assign contacts to agents available to handle those contacts. The assignments of contacts to agents can be made using various pairing strategies, and the selection of pairing strategies (and the proportion of time that different pairing strategies are used) can significantly affect the performance achieved by the contact center system.

When a contact center system uses multiple pairing strategies or switches between different pairing strategies, it can be difficult to measure the amount of performance change attributable to using one pairing strategy over another. In particular, some conditions allow performance differences between strategies to be reliably distinguished from noise and other factors, but other conditions do not allow performance differences to be clearly and accurately attributed. To achieve high performance and ensure high-quality performance analysis, a system can identify values or ranges for operating parameters that will yield high performance in the contact center system and also allow performance outcomes to be reliably attributed among multiple pairing strategies used.

As an example, based on historical contact-agent interaction data, the system can characterize typical conditions at the contact center system and results that have been achieved using a first pairing strategy. With this information, the system can evaluate a parameter space (e.g., a set of multiple variables or parameters) to determine a region of the parameter space where using a second pairing strategy satisfies a set of criteria (e.g., measurement conditions providing a minimum standard of reliability). For example, the set of criteria can specify conditions in which using the second pairing strategy will improve performance in the contact center system and the improvement can be reliably attributed to use of the second pairing strategy. With this evaluation, operating parameters for the contact center system can be set, such as the rate or proportion at which different pairing strategies are used. By using parameter values from the identified region of the parameter space, operators of the contact center system can have high confidence that using the second pairing strategy in the manner selected will improve performance and that the outcome data that will be generated will allow performance improvements to distinguishable from noise or other factors and be reliably attributable to the second pairing strategy.

In some implementations, the system facilitates determination of the settings for the contact center system by generating a visualization of the parameter space and the identified region that meets the criteria for performance improvement and measurement reliability. For example, the visualization can show incremental changes in performance that are predicted result from different levels of effectiveness of the second pairing strategy. The visualization can mark the identified region where performance improvement is significant enough to meet the reliability criteria that have been set. The visualization can also show the effects that different rates of using the second pairing strategy will have on performance. For example, the visualization can show how different usage rates for the second pairing strategy (e.g., 40% of the time, 60% of the time, and 80% of the time, etc.) yield different amounts of performance improvement compared to use of the first pairing strategy alone. With these and other features discussed below, the visualization can clearly show the combinations of parameter values that will result in verifiable performance improvements for the contact center system that are attributable to the use of the second pairing strategy.

In some implementations, the visualization can be provided in a user interface that includes interactive controls (e.g., sliders, input fields, drop-down boxes, etc.) that enable a user to vary the values for one or more of the parameters of the contact center or the pairing strategies used. For example, the controls can enable a user to vary parameters such as the amount of contacts occurring, the average performance of a first pairing strategy, the threshold for reliability in verifying performance improvement, and so on. As the user applies or changes settings using the controls, the system updates the analysis and the visualization to show the new regions in which performance improvements can be reliably verified with the conditions the user has set. In a similar manner, user interface controls can be provided to enable a user to set a target level of performance. Based on the analysis of the parameter space, the system can indicate, in the visualization and/or in another portion of the user interface, whether the target level of performance can be achieved in the region of verifiable performance improvement. If the target level of performance can be achieved within the region of reliable verification, the system can specify the parameter values that can achieve the target.

In some implementations, the analysis of the parameter space can be used to develop or refine pairing strategies. The analysis can be used predictively, to identify the characteristics that a pairing strategy needs in order to yield verifiable performance improvements. Even before a particular pairing strategy is used in a contact center, the analysis can show how different levels of effectiveness of the pairing strategy will impact performance results. This information can be used to determine a target level of effectiveness or to determine whether the needed level of effectiveness is feasible. For example, the analysis of the parameter space may reveal that, under typical conditions at the contact center, a new pairing strategy would need to outperform the existing pairing strategy by at least a minimum amount (e.g., 0.1%, 0.5%, 1.0%, 1.5%, etc.) in order to achieve a statistically significant level of performance improvement. This information can inform decisions such as whether to develop a customized pairing strategy for the contact center system, when a pairing strategy is ready to deploy, and/or what proportion of the time to use the pairing strategy. For example, some pairing strategies use a machine learning model that is trained to pair contacts with agents. When training a machine learning model, the training can be arranged to proceed until the model reaches at least the minimum effectiveness needed for verifiable performance improvement or another target characteristic (e.g., a level of effectiveness that provides a desired level of performance).

The analysis of the parameter space can be used to set a progression of operating parameters for a contact center system to provide increasingly greater performance, while remaining in conditions that permit reliable performance attribution. In many cases, a pairing strategy improves over time as additional interaction data is received. For example, for a pairing strategy that uses a machine learning model, results obtained from using the pairing strategies over time can serve as training data to further train and improve the machine learning model. This can lead to increased effectiveness over time, including higher levels of performance improvement with respect to a baseline pairing strategy or other reference. To take advantage of increasing effectiveness over time, a series of different operating parameter values can be planned to progressively improve overall performance of the contact center system over time as different performance levels of the pairing strategy are reached. Beyond simply improving performance, however, the system can plan the series of operating parameter values to maintain operation of the contact center system in the conditions where performance differences can be reliably determined for the pairing strategies used. For example, a series of settings can be determined that will remain in the target zone or region providing reliable performance attribution when multiple pairing strategies are used in an alternating manner.

For example, a series of parameter values for a contact center system can be selected to keep the contact center system operating within the determined region in the parameter space where performance improvements can be reliably verified. For example, the plan for a contact center system may specify to (1) begin using a second pairing strategy at a 40% usage rate once effectiveness is estimated to be 2% greater than the first pairing strategy, (2) switch to a 60% usage rate for the second pairing strategy once effectiveness is 2.5% greater than the first pairing strategy, and (3) switch to an 80% usage rate for the second pairing strategy once effectiveness is 3% greater than the first pairing strategy. This progression of settings can accelerate the improvement in overall performance of the contact center system while gathering interaction data to improve the second pairing strategy, while keeping operation of the contact center system in region of the parameter space where performance improvements can be reliably verified and attributed to the second pairing strategy. In this sense, the performance of the contact center system can be optimized within the constraint to ensure that performance measurements meet predetermined standards for reliability.

In one general aspect, a method performed by one or more computers includes: obtaining, by the one or more computers, historical contact-agent interaction data for a contact center system, wherein the historical contact-agent interaction data indicates performance of the contact center system using a first pairing strategy; identifying, by the one or more computers, a threshold level of reliability for evaluating pairing strategies for the contact center system; based on the historical contact-agent interaction data, determining, by the one or more computers, a region of a parameter space representing different combinations of parameter values for the contact center system, wherein the region spans ranges of values for each of multiple parameters and the region indicates combinations of parameter values for which performance improvements resulting from use of a second pairing strategy in combination with the first pairing strategy are identifiable with at least the threshold level of reliability as resulting from use of the second pairing strategy; selecting, by the one or more computers, a usage rate for the second pairing strategy, wherein the usage rate is selected based on the determined region in which performance improvements are identifiable with at least the threshold level of reliability as resulting from use of the second pairing strategy; and pairing, by the one or more computers, contacts and agents in the contact center system using the first pairing strategy and the second pairing strategy, wherein a usage rate of the second pairing strategy in the contact center system is based on the selected usage rate.

In some implementations, determining the region of the parameter space comprises defining a boundary of the region in the parameter space, wherein the boundary is defined by combinations of parameter values that provide the threshold level of reliability for identifying performance improvements and the boundary separates the region from regions of the parameter space representing combinations of parameter values that do not provide the threshold level of reliability for identifying performance improvements.

In some implementations, determining the region comprises defining a curve in the parameter space that bounds the region at combinations of parameters that provide the threshold level of reliability for identifying performance improvements.

In some implementations, the parameter space includes a range of parameter values for each of (i) a first parameter representing a level of estimated improvement of the second pairing strategy compared to the first pairing strategy and (ii) a second parameter quantifying incremental changes in outcomes at the contact center system resulting from use of the second pairing strategy in combination with the first pairing strategy.

In some implementations, determining the region of the parameter space comprises determining the region based on (i) a volume of contacts at the contact center system determined from the historical contact-agent interaction data and (ii) a measure of performance of the contact center system achieved when using the first pairing strategy.

In some implementations, the method includes identifying portions of the determined region that respectively correspond to different usage rates for using the second pairing strategy.

In some implementations, the method includes determining an estimated level of performance improvement that the second pairing strategy provides compared to the first pairing strategy, and selecting the usage rate for the second pairing strategy comprises selecting, from among multiple different usage rates, a usage rate that with the estimated level of performance improvement results in a combination of parameter values in the determined region.

In some implementations, the performance of the contact center system comprises an amount or rate that a predetermined outcome occurs for contacts at the contact center system, and wherein the performance improvements include an increase in the amount or rate at which the predetermined outcome occurs at the contact center system.

In some implementations, the method includes identifying a series of usage rates to apply for different estimated levels of improvement provided by the second pairing strategy compared to the first pairing strategy, wherein the series of usage rates and estimated levels of improvement provide progressively higher performance of the contact center system while remaining within the determined region in which performance improvements from the second pairing strategy are identifiable with at least the threshold level of reliability.

In some implementations, the method includes providing user interface data for a visualization that distinguishes the determined region from regions of the parameter space that do not provide the threshold level of reliability for identifying performance improvements.

In some implementations, the visualization indicates combinations of parameter values in the region that correspond to different usage rates of the second pairing strategy when used in combination with the first pairing strategy.

In some implementations, the visualization indicates measures of performance of the contact center system for each of multiple different aspects of performance, wherein the measures of performance are correlated so that the visualization indicate the expected measure of performance that would be achieved in the target region for each of the different aspects of performance.

In some implementations, selecting the usage rate for the second pairing strategy comprises selecting a usage rate that provides, for an estimated level of performance improvement that the second pairing strategy provides relative to the first pairing strategy, at least a minimum margin from a boundary of the determined region at which the threshold level of reliability is provided.

In some implementations, the second pairing strategy involves using a machine learning model to perform pairing of contacts and agents.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1A-1D are diagrams showing examples of communication systems.

FIG. 2 is an example of a system for assessing and improving contact center performance.

FIGS. 3A-3G are examples of map visualizations based on analysis of contact center performance.

FIGS. 4A-4B are examples of user interfaces showing interactive map visualizations.

FIG. 5 is a flow diagram illustrating an example of a process for assessing and improving contact center performance.

Like reference numbers and designations in the various drawings indicate like elements.

### DETAILED DESCRIPTION

A typical contact center algorithmically assigns contacts arriving at the contact center to agents available to handle those contacts. At times, the contact center may have agents available and waiting for assignment to inbound or outbound contacts (e.g., telephone calls, Internet chat sessions, email). At other times, the contact center may have contacts waiting in one or more queues for an agent to become available for assignment. The contact center may use pairing strategies to pair the contact(s) in queue with an agent available for assignment.

In addition to FIFO, PBR, and BP strategies, some contact centers may use a variety of other possible pairing strategies. For example, in a longest-available agent pairing strategy, an agent may be selected who has been waiting (idle) the longest time since the agent's most recent contact interaction (e.g., call) has ended. In a least-occupied agent pairing strategy, an agent may be selected who has the lowest ratio of contact interaction time to waiting or idle time (e.g., time spent on calls versus time spent off calls). In a fewest-contact-interactions-taken-by-agent pairing strategy, an agent may be selected who has the fewest total contact interactions or calls. In a randomly-selected-agent pairing strategy, an available agent may be selected at random (e.g., using a pseudorandom number generator). In a sequentially-labeled-agent pairing strategy, agents may be labeled sequentially, and the available agent with the next label in sequence may be selected.

In situations where multiple contacts are waiting in a queue, and an agent becomes available for connection to one of the contacts in the queue, a variety of pairing strategies may be used. For example, in a FIFO or longest-waiting-contact pairing strategy, the agent may be preferably paired with the contact that has been waiting in queue the longest (e.g., the contact at the head of the queue). In a randomly-selected-contact pairing strategy, the agent may be paired with a contact selected at random from among all or a subset of the contacts in the queue. In a priority-based routing or highest-priority-contact pairing strategy, the agent may be paired with a higher-priority contact even if a lower-priority contact has been waiting in the queue longer.

Contact centers may measure performance based on a variety of metrics. For example, a contact center may measure performance based on one or more of sales revenue, sales conversion rates, customer retention rates, average handle time, customer satisfaction (based on, e.g., customer surveys), etc. Regardless of what metric or combination of metrics a contact center uses to measure performance, or what pairing strategy (e.g., FIFO, PBR, BP) a contact center uses, performance may vary over time. For example, year-over-year contact center performance may vary as a company shrinks or grows over time or introduces new products or contact center campaigns. Month-to-month contact center performance may vary as a company goes through sales cycles, such as a busy holiday season selling period, or a heavy period of technical support requests following a new product or upgrade rollout. Day-to-day contact center performance may vary if, for example, customers are more likely to call during a weekend than on a weekday, or more likely to call on a Monday than a Friday. Intraday contact center performance may also vary. For example, customers may be more likely to call at when a contact center first opens (e.g., 8:00 AM), or during a lunch break (e.g., 12:00 PM), or in the evening after typical business hours (e.g., 6:00 PM), than at other times during the day. Intra-hour contact center performance may also vary. For example, more urgent, high-value contacts may be more likely to arrive the minute the contact center opens (e.g., 9:00 or 9:01) than even a little later (e.g., 9:05). Contact center performance may also vary depending on the number and caliber of agents working at a given time. For example, the 9:00-5:00 PM shift of agents may perform, on average, better than the 5:00-9:00 AM shift of agents.

These examples of variability at certain times of day or over larger time periods can make it difficult to attribute changes in performance over a given time period to a particular pairing strategy. For example, if a contact center used FIFO routing for one year with an average performance of 20% sales conversion rate, then switched to PBR in the second year with an average performance of 30% sales conversion rate, the apparent change in performance is a 50% improvement.

However, this contact center may not have a reliable way to know what the average performance in the second year would have been had it kept the contact center using FIFO routing instead of PBR. In real-world situations, at least some of the 50% gain in performance in the second year may be attributable to other factors or variables that were not controlled or measured. For example, the contact center may have retrained its agents or hired higher-performing agents, or the company may have introduced an improved product with better reception in the marketplace.

Consequently, contact centers may struggle to analyze the internal rate of return or return on investment from switching to a different to a different pairing strategy due to challenges associated with measuring performance gain attributable to the new pairing strategy.

In some implementations, a contact center system may switch (or “cycle”) periodically among at least two different pairing strategies (e.g., between FIFO and PBR; between PBR and BP; among FIFO, PBR, and BP). Additionally, the outcome of each contact-agent interaction may be recorded along with an identification of which pairing strategy (e.g., FIFO, PBR, or BP) had been used to assign that particular contact-agent pair. By tracking which interactions produced which results, the contact center may measure the performance attributable to a first strategy (e.g., FIFO) and the performance attributable to a second strategy (e.g., PBR). In this way, the relative performance of one strategy may be benchmarked against the other. The contact center may, over many periods of switching between different pairing strategies, more reliably attribute performance gain to one strategy or the other.

Several benchmarking techniques may achieve precisely measurable performance gain by reducing noise from confounding variables and eliminating bias in favor of one pairing strategy or another. In some implementations, benchmarking techniques may be time-based (“epoch benchmarking”). In other implementations, benchmarking techniques may involve randomization or counting (“inline benchmarking”). In other embodiments, benchmarking techniques may be a hybrid of epoch and inline benchmarking.

In epoch benchmarking, the switching frequency (or period duration) can affect the accuracy and fairness (e.g., statistical purity) of the benchmark. For example, assume the period is two years, switching each year between two different strategies. In this case, the contact center may use FIFO in the first year at a 20% conversion rate and PBR in the second year at a 30% conversion rate, and measure the gain as 50%. However, this period is too large to eliminate or otherwise control for expected variability in performance. Even shorter periods such as two months, switching between strategies each month, may be susceptible to similar effects. For example, if FIFO is used in November, and PBR is used December, some performance improvement in December may be attributable to increased holiday sales in December rather than the PBR itself.

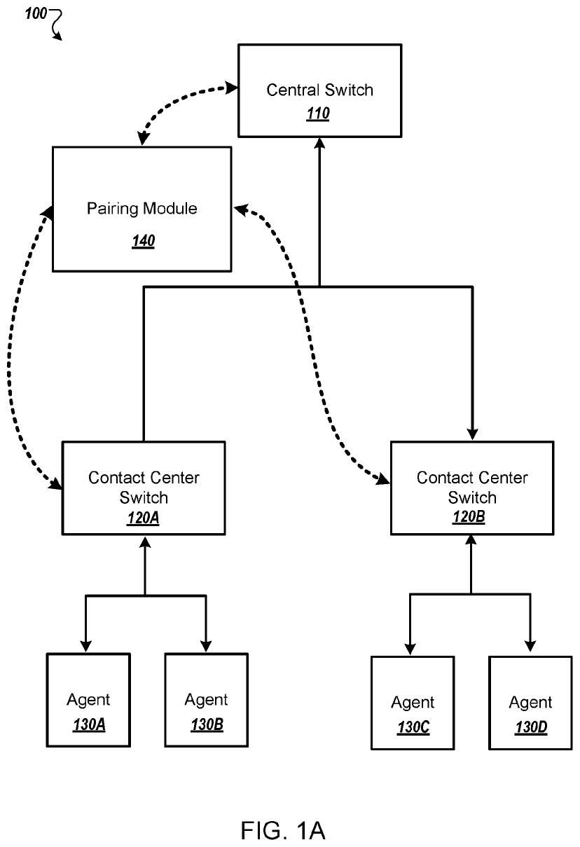

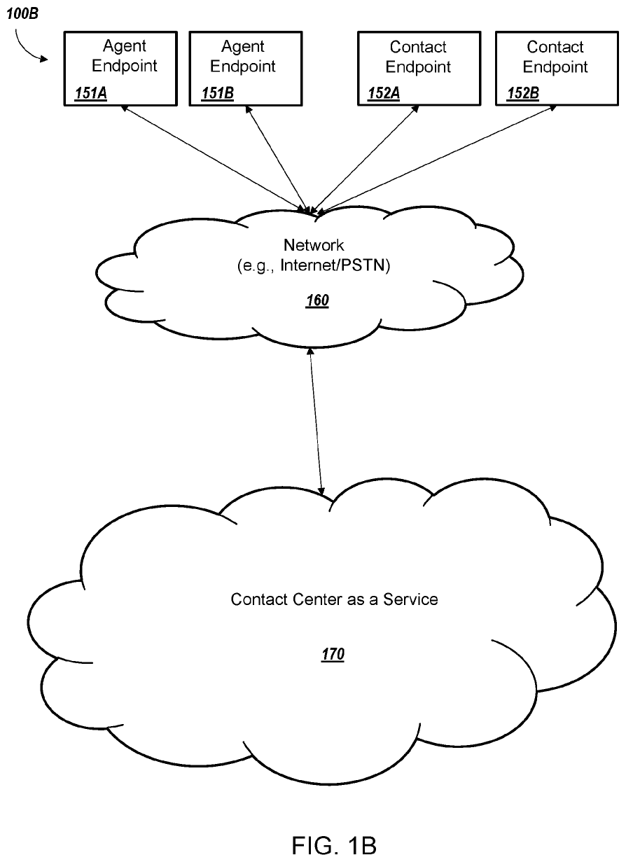

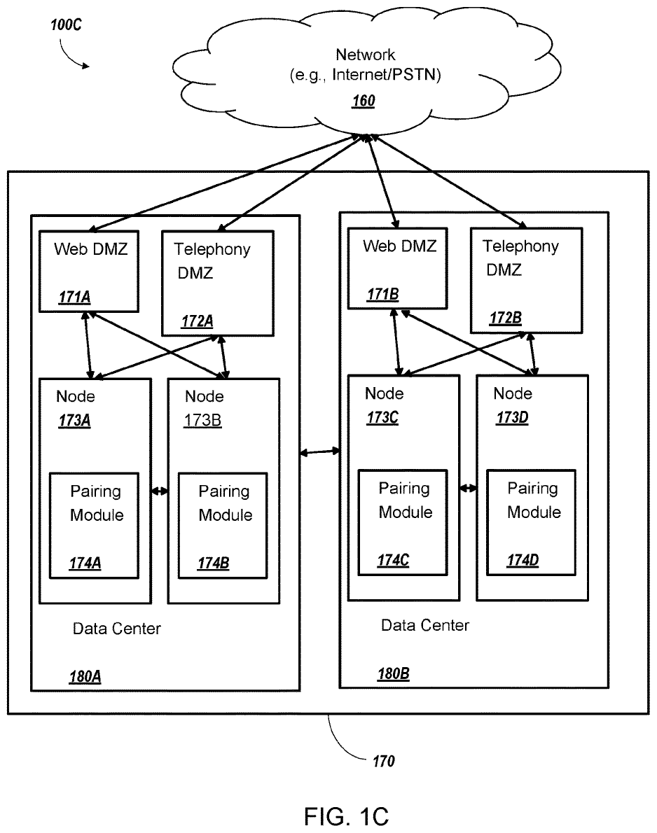

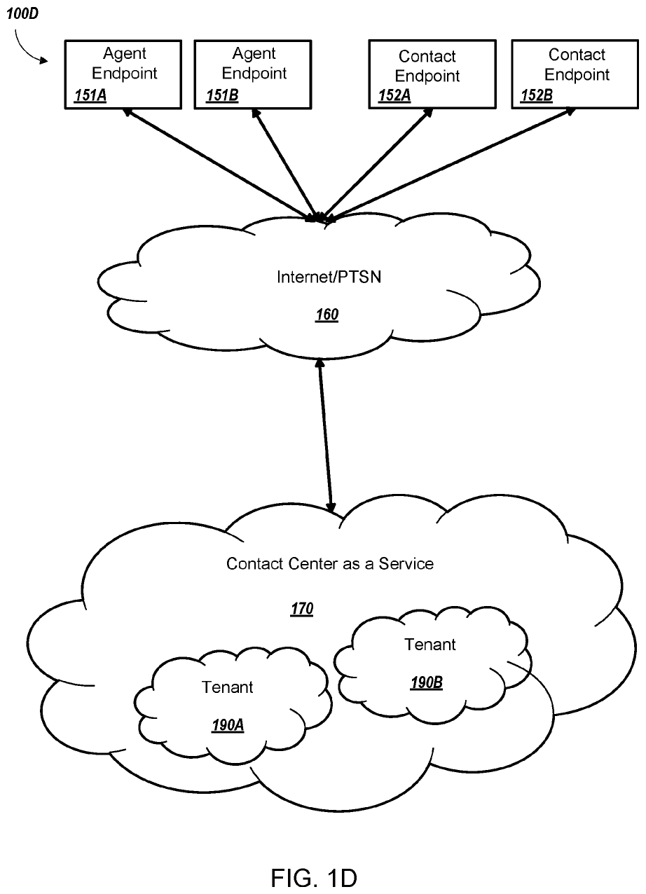

In some implementations, to reduce or minimize the effects of performance variability over time, the period that a pairing strategy is used before switching may be much shorter than a month (e.g., less than a day, less than an hour, less than twenty minutes). As an example, a contact center system may cycle between two pairing strategies over a period of 10 minutes, by switching pairing strategies every five minutes. For the first five minutes (e.g., 9:00-9:05 AM), the first pairing strategy (e.g., BP) may be used. After five minutes, the contact center may switch to the second pairing strategy (e.g., FIFO or PBR) for the remaining five minutes of the ten-minute period (9:05-9:10 AM). At 9:10 AM, the second period may begin, switching back to the first pairing strategy (not shown in FIG. 1A). If the period is 30 minutes, the first pairing strategy may be used for the first 15 minutes, and the second pairing strategy may be used for the second 15 minutes.

With short, intra-hour periods (10 minutes, 20 minutes, 30 minutes, etc.), the benchmark is less likely to be biased in favor of one pairing strategy or another based on long-term variability (e.g., year-over-year growth, month-to-month sales cycles). However, other factors of performance variability may persist. For example, if the contact center always applies the period shown in FIG. 1A when it opens in the morning, the contact center will always use the first strategy (BP) for the first five minutes. As explained above, the contacts who arrive at a contact center the moment it opens may be of a different type, urgency, value, or distribution of type/urgency/value than the contacts that arrive at other times of the hour or the day. Consequently, the benchmark may be biased in favor of the pairing strategy used at the beginning of the day (e.g., 9:00 AM) each day.

In some implementations, to reduce or minimize the effects of performance variability over even short periods of time, the order in which pairing strategies are used within each period may change. For example, the contact center may start with the second pairing strategy (e.g., FIFO or PBR) for the first five minutes, then switch to the first pairing strategy (BP) for the following five minutes.

In some embodiments, to help ensure trust and fairness in the benchmarking system, the benchmarking schedule may be established and published or otherwise shared with contact center management ahead or other users of time. In some embodiments, contact center management or other users may be given direct, real-time control over the benchmarking schedule, such as using a computer program interface to control the cycle duration and the ordering of pairing strategies.

Embodiments of the present disclosure may use any of a variety of techniques for varying the order in which the pairing strategies are used within each period. For example, the contact center may alternate each hour (or each day or each month) between starting with a first ordering and starting with a different, second ordering. In other embodiments, an ordering can be selected randomly for each period (e.g., approximately 50% of the periods in a given day use a first ordering, and approximately 50% of the periods in a given day use a second ordering, with a uniform and random distribution of orderings among the periods).

A contact center system can use multiple pairing strategies can at different rates or different proportions. For epoch benchmarking, multiple pairing strategies can be used for different proportions of time during a period. When a BP pairing strategy is used for the same amount of time as another pairing strategy within each period (e.g., five minutes each), the “duty cycle” for BP is 50%. However, notwithstanding other variables affecting performance, some pairing strategies are expected to perform better than others. For example, BP is expected to perform better than FIFO. Consequently, a contact center may wish to use BP for a greater proportion of time than FIFO-so that more pairings are made using the higher-performing pairing strategy. Thus, the contact center may prefer a higher duty cycle (e.g., 60%, 70%, 80%, 90%, etc.) for BP representing more time (or a greater proportion of contacts) paired using the higher-performing pairing strategy. As an example, a contact center system can use a ten-minute period with an 80% duty cycle for BP. For the first eight minutes (e.g., 9:00-9:08 AM), the first pairing strategy (e.g., BP) may be used. After the first eight minutes, the contact center may switch to the second pairing strategy (e.g., FIFO) for the remaining two minutes of the period (9:08-9:10) before switching back to the first pairing strategy again. If, for another example, a thirty-minute period is used, the first pairing strategy may be used for the first twenty-four minutes (e.g., 9:00-9:24 AM), and the second pairing strategy may be used for the next six minutes (e.g., 9:24-9:30 AM).

As another example, the contact center may proceed through six ten-minute periods over the course of an hour. In this example, each ten-minute period has an 80% duty cycle favoring the first pairing strategy, and the ordering within each period starts with the favored first pairing strategy. Over the hour, the contact center system may switch pairing strategies twelve times (e.g., at 9:08, 9:10, 9:18, 9:20, 9:28, 9:30, 9:38, 9:40, 9:48, 9:50, 9:58, and 10:00). Within the hour, the first pairing strategy was used a total of 80% of the time (48 minutes), and the second pairing strategy was used the other 20% of the time (12 minutes). For a thirty-minute period with an 80% duty cycle (not shown), over the hour, the contact center may switch pairing strategies four times (e.g., at 9:24, 9:30, 9:48, and 10:00), and the total remains 48 minutes using the first pairing strategy and 12 minute using the second pairing strategy.

A contact center system can also set the rates or proportions at which to use multiple pairing strategies when using inline benchmarking. With inline benchmarking techniques, pairing strategies may be selected on a contact-by-contact basis. For example, assume that approximately 50% of contacts arriving at a contact center should be paired using a first pairing method (e.g., FIFO), and the other 50% of contacts should be paired using a second pairing method (e.g., BP).

Each contact may be randomly designated for pairing using one method or the other with a 50% probability. The selection of pairing strategy can be shifted or weighted to provide a higher probability of selection of a particular pairing strategy (e.g., 60%, 80%, etc.) to set a higher proportion of use for that pairing strategy.

In other implementations, contacts may be sequentially designated according to a particular period. For example, a predetermined number of contacts (e.g., the first five, or ten, or twenty, etc.) contacts may be designated for a FIFO strategy, and then a predetermined number of contacts (e.g., the next five, or ten, or twenty, etc.) may be designated for a BP strategy. Other percentages and proportions may also be used, such as 60% (or 80%, etc.) paired with a BP strategy and the other 40% (or 20%, etc.) paired with a FIFO strategy.

From time to time, a contact may return to a contact center (e.g., call back) multiple times. In particular, some contacts may require multiple “touches” (e.g., multiple interactions with one or more contact center agents) to resolve an issue. In these cases, it may be desirable to ensure that a contact is paired using the same pairing strategy each time the contact returns to the contact center. If the same pairing strategy is used for each touch, then the benchmarking technique will ensure that this single pairing strategy is associated with the final outcome (e.g., resolution) of the multiple contact-agent interactions. In other situations, it may be desirable to switch pairing strategies each time a contact returns to the contact center, so that each pairing strategy may have an equal chance to be used during the pairing that resolves the contact's needs and produces the final outcome. In yet other situations, it may be desirable to select pairing strategies without regard to whether a contact has contacted the contact center about the same issue multiple times.

In some embodiments, the determination of whether a repeat contact should be designated for the same (or different) pairing strategy may depend on other factors. For example, there may be a time limit, such that the contact must return to the contact center within a specified time period for prior pairing strategies to be considered (e.g., within an hour, within a day, within a week). In other embodiments, the pairing strategy used in the first interaction may be considered regardless of how much time has passed since the first interaction.

For another example, repeat contact may be limited to specific skill queues or customer needs. Consider a contact who called a contact center and requested to speak to a customer service agent regarding the contact's bill. The contact hangs up and then calls back a few minutes later and requests to speak to a technical support agent regarding the contact's technical difficulties. In this case, the second call may be considered a new issue rather than a second “touch” regarding the billing issue. In this second call, it may be determined that the pairing strategy used in the first call is irrelevant to the second call. In other embodiments, the pairing strategy used in the first call may be considered regardless of why the contact has returned to the contact center. Contact center systems can use additional techniques for selecting pairing strategies and benchmarking performance as discussed in U.S. Pat. No. 9,774,740, which is incorporated herein by reference.

FIG. 1A illustrates an example communication system 100A. In this example, communication system 100A is a contact center system. As shown in FIG. 1A, the communication system 100A may include a central switch 110. The central switch 110 may receive incoming contacts (e.g., callers) or support outbound connections to contacts via a telecommunications network (not shown). The central switch 110 may include contact routing hardware and software for helping to route contacts among one or more contact centers, or to one or more Private Branch Exchanges (PBXs) and/or Automatic Call Distributers (ACDs) or other queuing or switching components, including other Internet-based, cloud-based, or otherwise networked contact-agent hardware or software-based contact center solutions.

The central switch 110 may not be necessary such as if there is only one contact center, or if there is only one PBX/ACD routing component, in the communication system 100A. If more than one contact center is part of the communication system 100A, each contact center may include at least one contact center switch (e.g., contact center switches 120A and 120B). The contact center switches 120A and 120B may be communicatively coupled to the central switch 110. In embodiments, various topologies of routing and network components may be configured to implement the contact center system.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 1A, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B.

The communication system 100A may also be communicatively coupled to an integrated service from, for example, a third party vendor. In the example of FIG. 1A, a pairing module 140 may be communicatively coupled to one or more switches in the switch system of the communication system 100A, such as central switch 110, contact center switch 120A, or contact center switch 120B. In some embodiments, switches of the communication system 100A may be communicatively coupled to multiple pairing modules or pairing nodes. In some embodiments, pairing module 140 may be embedded within a component of a contact center system (e.g., embedded in or otherwise integrated with a switch). The pairing module 140 may receive information from a switch (e.g., contact center switch 120A) about agents logged into the switch (e.g., agents 130A and 130B) and about incoming contacts via another switch (e.g., central switch 110) or, in some embodiments, from a network (e.g., the Internet or a telecommunications network) (not shown).

A contact center may include multiple pairing modules or pairing nodes. In some embodiments, one or more pairing modules may be components of pairing module 140 or one or more switches such as central switch 110 or contact center switches 120A and 120B. In some embodiments, a pairing module may determine which pairing module may handle pairing for a particular contact. For example, the pairing module may alternate between enabling pairing via a Behavioral Pairing (BP) strategy and enabling pairing with a First-in-First-out (FIFO) strategy. In other embodiments, one pairing module (e.g., the BP pairing module) may be configured to emulate other pairing strategies.

FIG. 1B illustrates a second example communication system 100B. As shown in FIG. 1B, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 152A, 152B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN), according to the capabilities of the endpoint device.

FIG. 1C illustrates an example communication system 100C with an example configuration of a CCaaS 170. For example, a CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone equipment 171A and 171B, respectively, which is configured to receive the agent endpoints 151A, 151B and contact endpoints 152A, 152B, which are communicatively connecting to CCaaS via the Internet. Web demilitarized zone (DMZ) equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS via the PSTN.

Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to pairing module 140 of communications system 100A of FIG. 1A, pairing modules 174A, 174B, 174C, 174D may pair contacts to agents. For example, the pairing module may alternate between enabling pairing via a Behavioral Pairing (BP) module and enabling pairing with a First-in-First-out (FIFO) module. In other embodiments, one pairing module (e.g., the BP module) may be configured to emulate other pairing strategies.

Turning now to FIG. 1D, the disclosed CCaaS communication systems (e.g., FIGS. 1B and/or 1C) may support multi-tenancy such that multiple contact centers (or contact center operations or businesses) may be operated on a shared environment. That is, each tenant may have a separate, non-overlapping pool of agents. CCaaS 170 is shown in FIG. 1D as comprising two tenants 190A and 190B. Turning back to FIG. 1C, for example, multi-tenancy may be supported by node 173A supporting tenant 190A while node 173B supports tenant 190B. In another embodiment, data center 180A supports tenant 190A while data center 180B supports tenant 190B. In another example, multi-tenancy may be supported through a shared machine or shared virtual machine; such at node 173A may support both tenants 190A and 190B, and similarly for nodes 173B, 173C, and 173D.

In other embodiments, the system may be configured for a single tenant within a dedicated environment such as a private machine or private virtual machine.

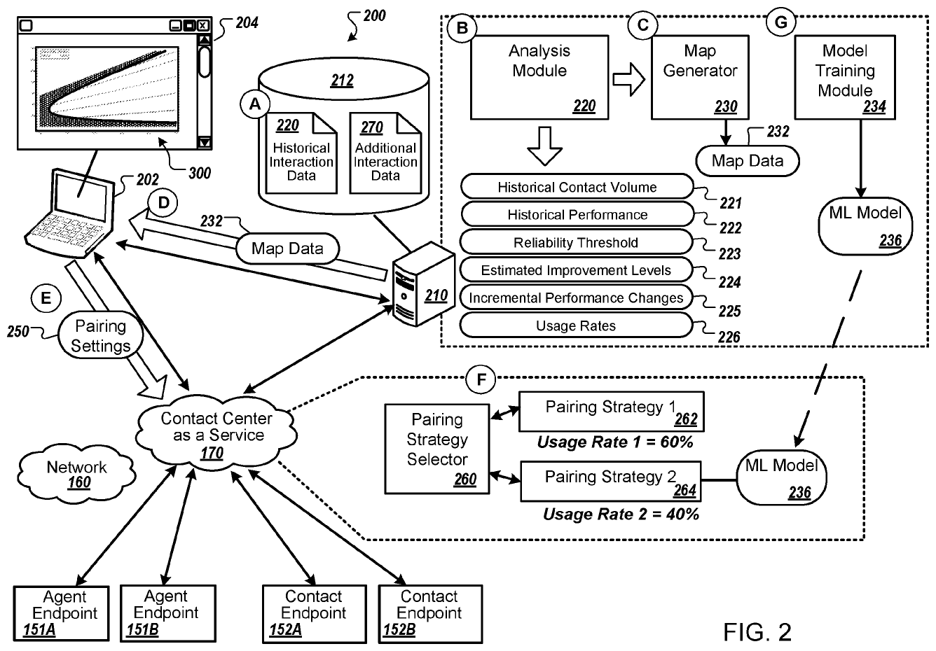

FIG. 2 is a block diagram showing an example of a system 200 that employs techniques for assessing and improving performance of a contact center system. In the system 200, the CCaaS 170 communicates with contact endpoints 152A-152B and agent endpoints 151A-151B through the network 160 as discussed above for FIGS. 1B-1D. The system 200 also includes a computer system 210 that analyzes the performance of the CCaaS 170 and provides results of the analysis to a client device 202 over the network 160. Based on the results of the analysis, the operation of the CCaaS 170 can be adjusted, such as to set or alter the usage rate of various paring strategies. FIG. 2 shows a series of stages labeled (A) to (G), which represent processing and the flow of data in the system 200. These stages can be performed in the order indicated or in a different order.

In the example, the computer system 210 analyzes historical performance of the CCaaS 170 and estimates how various combinations of parameter values will affect the performance of the CCaaS 170. From the analysis, the computer system 210 can create visualizations (e.g., charts, graphs, etc.) and other representations that indicate which combinations of parameter values can improve performance of the CCaaS 170. In this process, the computer system 210 can determine and indicate the regions of a parameter space (e.g., values or ranges of values for various parameters) that can improve performance while also permitting a desired level of reliability or confidence in attributing performance improvements based on the interaction data that will be produced.

For example, the computer system 210 can analyze historical data indicating performance of the CCaaS 170 when using a first pairing strategy. The computer system 210 can then generate data for a map visualization that indicates operating conditions for the CCaaS 170 in which alternating between the first pairing strategy and a second pairing strategy is predicted to improve performance to an extent that the performance improvements can be reliably attributed to the second pairing strategy. The map visualization and associated analysis provide the guidance to adjust the CCaaS 170 to operate in the region where performance improves and where improvements can be reliably characterized based on tracked outcomes of the two pairing strategies used in an alternating manner.

In many cases, the performance of a contact center system can be improved by adding an additional pairing strategy that is used for at least some contacts (e.g., at least some of the time). For example, in a contact center system that uses a FIFO pairing strategy or a PBR pairing strategy, overall performance may be improved by additionally using a BP pairing strategy during the contact center's operation. However, as discussed above, attributing performance results to different pairing strategies can be challenging when multiple pairing strategies are used, and when multiple factors may pollute performance analysis, as discussed previously herein. Under some conditions, adding a second pairing strategy may improve performance of a contact center system but not significantly enough for the improvement to be distinguished from noise, random variation, or other measurement artifacts. When performance cannot be reliably characterized, there is increased uncertainty about the effectiveness of the pairing strategies and the operating settings that would be best for the contact center system. On the other hand, if the performance data reliably shows that use of the second pairing strategy provides a significant performance improvement, then the results provide high confidence to maintain or increase use of the second pairing strategy. The computer system 210 provides functionality to predict settings and conditions that will produce outcome data allowing high-confidence performance attribution, often even before the second pairing strategy is used in the contact center system.

In the example, the computer system 210 helps maintain the CCaaS 170 operating in conditions where the performance contributions of different pairing strategies can be reliably distinguished. For example, the computer system 210 can predictively determine which ranges of operating parameter values will allow for reliable performance attribution and which will not. This allows operating parameters to be set so that the CCaaS 170 has a high likelihood of operating in the regions or zones where performance can be reliably characterized, which leads to more predictable performance outcomes and better monitoring data to support setting operating parameters in the future.

The computer system 210 can be any appropriate computer system, for example, a desktop computer, a laptop computer, or one or more computers of a server system (e.g., an on-premises server, a remote server, a data center, a cloud computing system, etc.).

Briefly, the computer system 210 obtains historical interaction data about the operation of the CCaaS 170 and then uses that data to characterize existing conditions (e.g., results using a first pairing strategy). The computer system 210 then estimates or predicts the effects of changing the pairing strategies used (e.g., using a second pairing strategy along with the first pairing strategy). For example, the computer system 210 can generate a visualization to show how varying characteristics such as the usage rates of different pairing strategies will change the performance of the CCaaS 170, and which conditions will provide a desired level of reliability in attributing performance among the pairing strategies. The computer system 210 can provide the results of its analysis, including data for the visualization, to the client device 202, which can then set operating parameters for the CCaaS 170 (e.g., usage rates for pairing strategies) estimated to reach desired performance levels while operating in the target region the desired level of reliability of performance attribution. In some examples, the computer system 210 may provide the operating parameters to the client device 202, based on the analysis and/or the data for the visualization. In other examples, the computer system 210 may itself set the operating parameters for the CCaaS 170 based on the analysis and/or the data for the visualization. Therefore, these updated parameters can improve the performance that the CCaaS 170 achieves as well as the quality of performance monitoring and confidence in performance attribution for the CCaaS 170.

In further detail, in stage (A), the computer system 210 obtains historical interaction data 214 about the CCaaS 170. The historical interaction data 214 can indicate, among other items, the volume of contacts that occur at the CCaaS 170, contact information data, agent information data, interaction outcome data, contact-agent pairing data, interaction timing data, interaction pairing strategy data, abandon rate data, and other contact center data as known in the art, and the performance that has been achieved at the CCaaS 170 with the current pairing strategy (or current pairing strategies) used at the CCaaS 170. This information can be provided in various forms, such as through aggregate measures (e.g., totals, averages, distributions, etc.) or through information about individual contacts, individual agents, and the resulting contact-agent interactions.

The historical interaction data 214 can describe previous contact-agent interactions with a log of contacts (e.g., calls, e-mails, text messages, etc.) that occurred at the CCaaS 170 and information about the outcomes of those interactions. This historical interaction data 214 can further include contact information regarding a contact's interaction with an enterprise client associated with the CCaaS 170 that did not occur at the CCaaS 170 (e.g., website purchases, in-store purchases, etc.). Various types of events or conditions resulting from the contacts can be tracked and indicated in the historical interaction data 214. For example, the outcomes can indicate whether a sale occurred, a number of units sold, an amount of value of a transaction, whether an existing customer was retained, a user satisfaction rating, a duration of an interaction session with the agent, whether an on-site visit was made and whether it was determined to be necessary, and so on. In general, the historical interaction data 214 can indicate outcomes or results for any of various dimensions of performance that are desirable to be monitored or improved (e.g., conversion rate, customer satisfaction, call duration, offer/resource allocation, etc.). When appropriate, the information about individual contact-agent interactions can specify which pairing strategy was used to assign each contact to an agent. The historical interaction data 214 may also include information that specifies identifiers for contacts and/or agents, profile information for the contacts and/or agents, and other information about the interactions that occurred.

In the example, the computer system 210 stores historical interaction data 214 including an interaction log for the CCaaS 170 in a database 212. The historical interaction data 214 describes contacts received over a period of time (e.g., 3 months, 6 months, a year, etc.) in which contacts were paired with agents using a first pairing strategy 262 labeled “Pairing Strategy 1.” The historical interaction data 214 also includes information about the outcomes of those contacts.

In stage (B), the computer system 210 analyzes the historical interaction data 214 to characterize prior performance and estimate the effects of various parameter values on future performance. For example, the computer system 210 uses the historical interaction data 214 to characterize the amount of contacts that have previously occurred and the performance results from pairing using the first pairing strategy 262. The computer system 210 also estimates or predicts how using the second pairing strategy 264 (“Pairing Strategy 2”) intermittently along with the first pairing strategy 262 would affect performance, for various usage rates of the second pairing strategy 264 and the first pairing strategy 262.

The computer system 210 can use a software module, such as an analysis module 220, to evaluate the interaction of various parameters on the performance of the CCaaS 170. For example, the analysis module 220 can determine the typical quantity and characteristics of the contacts that are typically handled at the CCaaS 170. For example, the analysis module 220 can determine a historical contact volume 221, such as an amount of contacts that have occurred per unit of time (e.g., an average amount of interaction events per month) as indicated by the historical interaction data 214. The analysis module 220 can also determine measures of historical performance 222 of the CCaaS 170 that resulted from the contact-agent interactions indicated by the historical interaction data 214. For example, the analysis module 220 can determine a conversion rate, such as a percentage of contacts described in the historical interaction data 214 that resulted in a sale or other desirable outcome. Other types of performance may additionally or alternatively calculated, such as an average customer satisfaction rating, an average interaction duration, an average interaction wait time, etc.

When performing analysis for the CCaaS 170, the computer system 210 can also calculate or obtain other values that affect how analysis is performed. For example, the analysis module 220 can identify a reliability threshold 223 that represents a minimum level of reliability that is desired for performance attribution.

As an example, the analysis module 220 may use statistical significance to measure reliability, and so may set a threshold for a p-value (e.g., a level of marginal significance within a statistical hypothesis test). For example, to set the criteria to specify whether monitoring conditions are acceptably reliable, the analysis module 220 can set a p-value threshold of, for example, 0.1, 0.05, etc.

The analysis module 220 can retrieve and use the predetermined p-value threshold in further analysis, and conditions resulting in a p-value below the predetermined threshold can be considered to provide acceptable reliability. For example, a p-value of 0.1 can be set to represent that, when alternating between the first pairing strategy 262 and the second pairing strategy 264, acceptable operating conditions should enable attribution of performance improvements to the second pairing strategy 264 with a p-value of less than 0.1.

Even before the pairing strategies 262, 264 are used together, the analysis can determine the conditions that would allow performance improvements to be reliably attributed based on a data set describing a period in which the CCaaS 170 alternates between the pairing strategies 262, 264. To accurately characterize performance, it is typically insufficient to simply compare performance of the second pairing strategy 264 during a single time period with performance of a first pairing strategy 262 over a single second, different period. For example, if the first pairing strategy 262 is used exclusively for a first month and the second pairing strategy 264 is use exclusively for a second month, the comparison of performance between the two would be of low accuracy because the conditions experienced in the CCaaS 170 (e.g., the properties of the contacts received and agents available) may be significantly different from one month to the next.

Conditions in a queue of contacts can change very quickly, often day by day or even hour by hour. Variations due to seasonality, the types of contacts received, the agents available, and other factors can all cause the results to be different in one period of time than another, separate from the difference in capabilities of the pairing strategies 262, 264 that the monitoring is intending to measure. To limit the effect of these variations on performance comparisons, it is important for the performance of the pairing strategies 262, 264 to be measured over similar time periods, e.g., a period in which the CCaaS 170 cycles frequently between the two pairing strategies 262, 264 (e.g., intra-day period with multiple cycles between the two pairing strategies). This can generate analysis of performance results with the pairing strategies 262, 264 operating under conditions that are as similar as possible, to minimize the amount of error introduced in either the performance results or the analysis. The system, in turn, needs to be able to reliably attribute performance based on this type of performance data, e.g., performance results for a period of frequent cycling between the pairing strategies 262, 264. However, even performance data gathered in this manner may have characteristics that prevent reliable performance attribution under certain conditions (e.g., too high a usage rate of the second pairing strategy 264, too low of a usage rate of the second pairing strategy 264, very similar performance of the pairing strategies 262, 264, etc.). As discussed further below, the computer system 210 can perform analysis to predict the range of operating conditions that will produce a data set with the properties needed for reliable performance attribution, so the CCaaS 170 can then be operated under those conditions to generate a monitoring data set that has the desired properties.

With the historical contact volume 221, the measures of historical performance 222 (e.g., performance when using the first pairing strategy alone), and the reliability threshold 223, the computer system 210 can analyze how combinations of various parameters affect performance and can analyze the quality of performance monitoring data. This can involve evaluating various regions of a parameter space to determine the conditions where using the first pairing strategy 262 and the second pairing strategy 264 is predicted to satisfy the reliability threshold 223 and potentially other criteria, such as providing at least a minimum amount of performance improvement to the CCaaS 170. For example, the analysis module 220 can consider a parameter space of multiple dimensions that includes ranges of values for estimated improvement levels 224 and incremental performance changes 225.

One dimension of the parameter space can represent estimated levels of improvement 224 of the second pairing strategy 264 relative to the first pairing strategy. Typically, the performance level that the second pairing strategy 264 will achieve in the CCaaS 170 is not known initially, and so the amount of performance improvement the second pairing strategy 264 provides over the first pairing strategy 262 is also not initially known. Nevertheless, the analysis module 220 can estimate how performance of the CCaaS 170 would be affected across a range of estimated improvement levels 224 of the second pairing strategy 264 compared to the first pairing strategy 262. For example, the range of estimated improvement levels 224 can be from 1.5% to 4%, to evaluate the potential effects of the second pairing strategy 264 being anywhere from 1.5% to 4% more effective than the first pairing strategy 262.

Another dimension of the parameter space can represent incremental performance changes 225 resulting from use of the second pairing strategy 264 along with the first pairing strategy 262. When the second pairing strategy 264 performs better than the first pairing strategy 262, using the second pairing strategy 264 for at least some contacts will increase overall performance of the CCaaS 170. The incremental performance changes 225 can indicate the amount of performance change that is expected to occur, e.g., additional sales or resource allocation of 100 units, 200 units, 300 units, etc. over the baseline level expected by using the first pairing strategy 262 alone. The actual change in performance achieved in a situation (e.g., increased quantity of desirable outcomes, decreased quantity of undesirable outcomes, etc.) will depend on the various factors affecting the CCaaS 170, including the amount of contacts, the level or improvement of the second pairing strategy 264 over the first pairing strategy 262, and the usage rates of the second pairing strategy 264 and the first pairing strategy 262.

The analysis module 220 can estimate the combinations of values in the parameter space (e.g., across various estimated improvement levels 224 and incremental performance changes 225) that will satisfy the reliability threshold 223. Often, performance improvements resulting from use of the second pairing strategy 264 may be identifiable and attributable with at least the minimum level of reliability for some combinations of parameter values but not others. The analysis module 220 can calculate the boundary through the parameter space that divides a region representing parameter values with appropriate reliability and one or more regions that do not provide appropriate reliability. For example, the boundary can be a curve representing reliability at the level of the reliability threshold 223, which then bounds a target region of the parameter space where using the first pairing strategy 262 and the second pairing strategy 264 are predicted to improve performance of the CCaaS 170 and to allow reliable attribution of the performance improvements.

The analysis module 220 can also determine how different usage rates 226 of the second pairing strategy 264 affect performance and reliability of attributing performance improvements. For example, if the relative improvement in performance of the second pairing strategy 264 over the first pairing strategy 262 is small, then using the second pairing strategy 264 for only 10% or 20% of the contacts in the CCaaS 170 may not yield an amount of performance improvement sufficient to reliably demonstrate that the second pairing strategy 264 is more effective. However, using the second pairing strategy 264 for 40% or 50% of the contacts in the CCaaS 170 may produce a sufficient amount of incremental performance change 225 to reach the target region of the parameter space where the reliability threshold 223 is satisfied. The analysis module 220 can determine the effect of different usage rates 226 of the second pairing strategy 264 over the parameter space (e.g., across ranges of the estimated improvement levels 224 and incremental performance changes 225). The results can indicate how each of different usage rates, together with other parameter values, can enable the CCaaS 170 to use the first pairing strategy 262 and second pairing strategy 264 within the target region where performance improves and the reliability threshold 223 is satisfied.

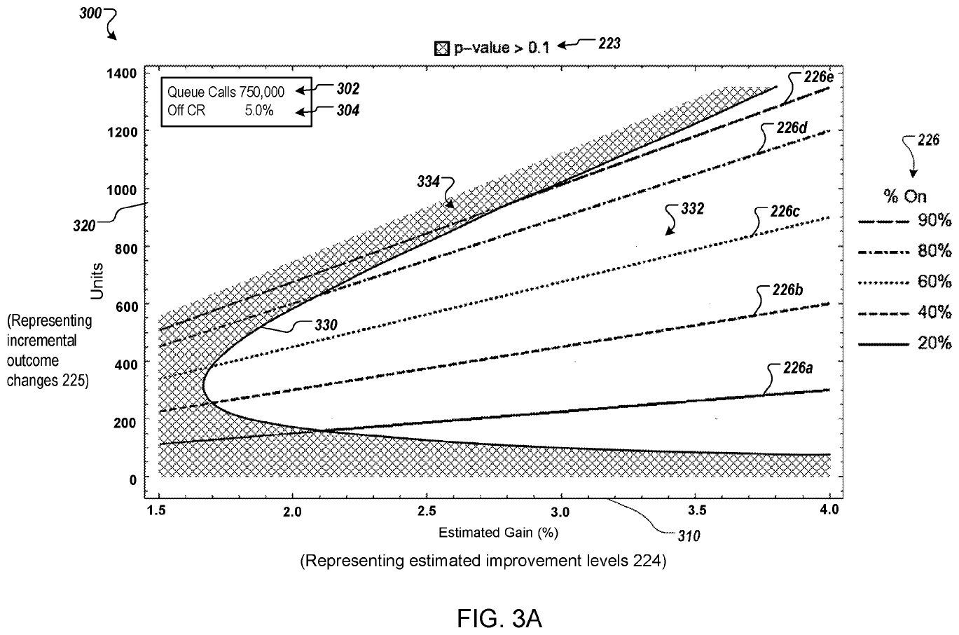

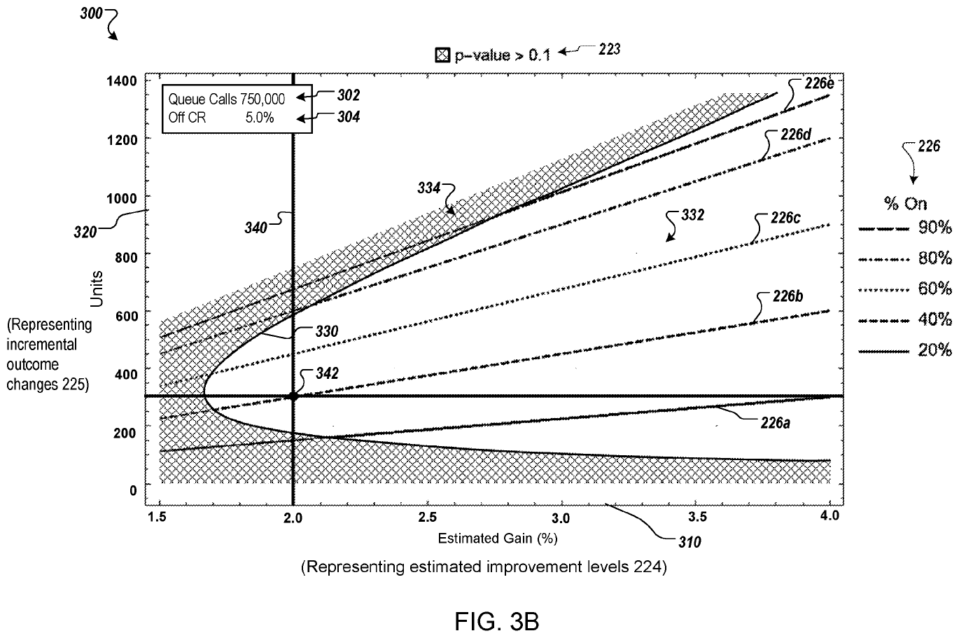

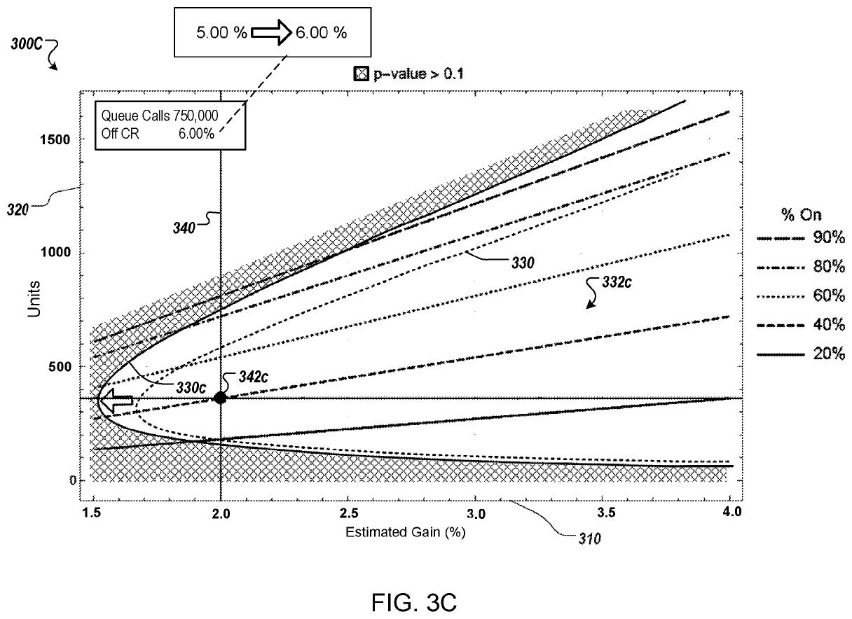

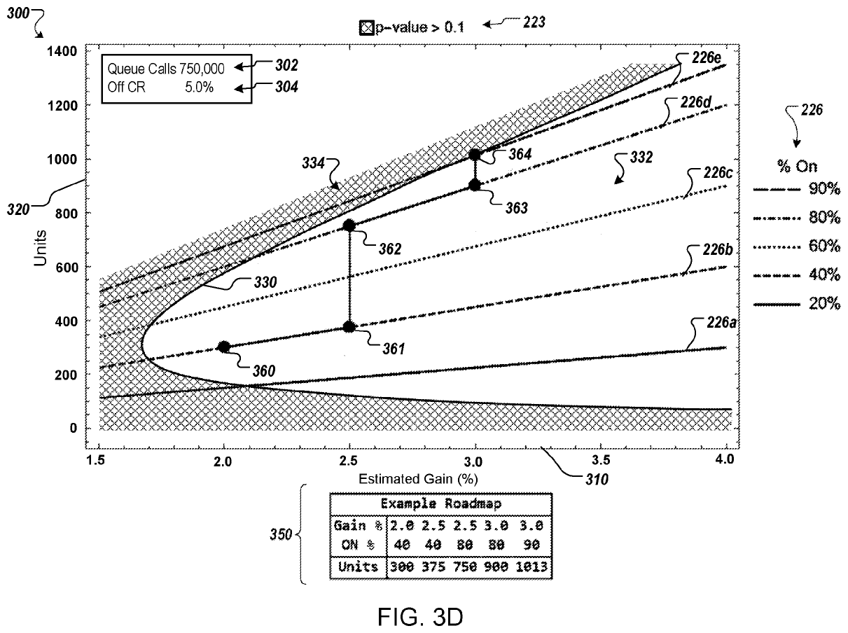

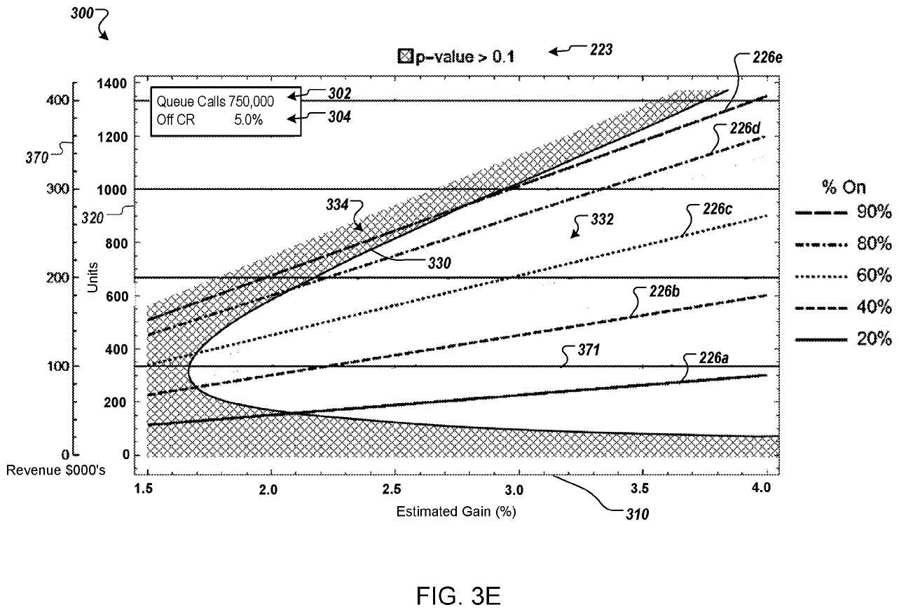

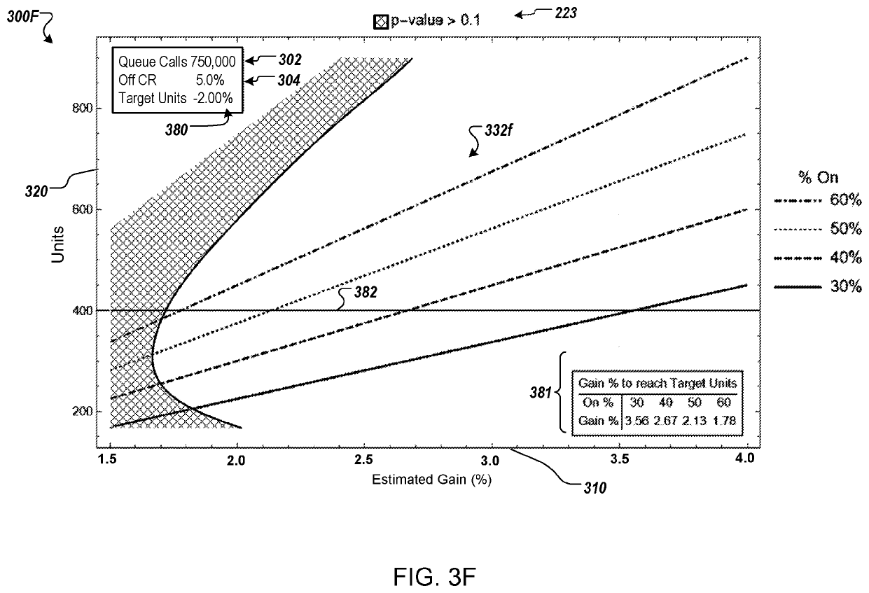

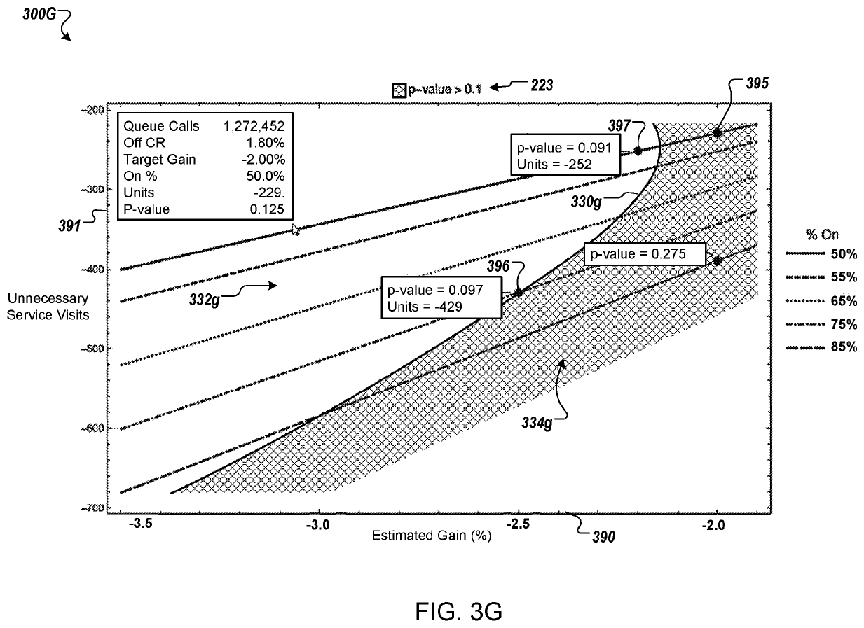

In stage (C), the computer system 210 can generate data for a visualization to represent the analysis performed by the analysis module 220. The computer system 210 can include a map generator 230 that generates map visualizations for the parameter space analyzed. For example, the map generator 230 can generate map data 232 that, when rendered, provides a map visualization 300 (FIG. 3A) that identifies the target region where parameter values provide performance improvement while satisfying the reliability threshold 223. The map data 232 can encode the information for the map visualization 300 in any appropriate form, such as image data (e.g., bitmap data, vector graphics, etc.), markup language (e.g., HTML, XML, etc.), a document, a data series to be plotted, and so on.

Referring to FIG. 3A, the map visualization 300 can provide a two-dimensional chart or graph showing at least a portion of the parameter space analyzed. The map visualization 300 is based on the analysis by the analysis module 220, which can estimate that contacts will continue to occur in the CCaaS 170 with the quantity or frequency indicated by the historical contact volume 221, which is represented in the example by the estimated number of calls 302 (in other examples, this may be the estimated number of interactions, etc.). The analysis module 220 can also estimate that the first pairing strategy 262 will yield performance as indicated by the historical performance 222, which is represented in the example as a conversion rate (CR) 304 of the first pairing strategy 262. This conversion rate is labeled “Off CR” to indicate that this is the expected conversion rate when the second pairing strategy 264 is off or disabled, so that only the first pairing strategy 262 is used. With this baseline information set, the analysis module 220 can determine the combinations of values for the estimated improvement levels 224 and incremental performance changes 225 (e.g., changes in outcomes) that will provide a measure of reliability that meets the reliability threshold 223.

The example of FIG. 3A has a horizontal axis 310 and a vertical axis 320. The horizontal axis 310 spans a range of values for the estimated improvement levels 224, which represent the level of performance improvement the second pairing strategy 264 provides over the first pairing strategy 262. For example, the horizontal axis 310 shows percentages of the estimated gain in performance (e.g., from 1.5% to 4%) that the second pairing strategy 264 may provide.

The vertical axis 320 represents a range of incremental performance changes 225 that may result. The example of FIG. 3A shows performance measured in the number of units sold, and so the vertical axis 320 indicates increases in the number of units sold that results from use of the second pairing strategy 264 together with the first pairing strategy 262 instead of using the first pairing strategy 262 alone. Using the first pairing strategy 262 alone is expected to produce a baseline level of sales (e.g., at the rate determined from the historical interaction data 214). The baseline level is represented by zero incremental additional sales, and each of the higher values on the vertical axis 320 represent net increases in units sold as a result of pairing some contacts using the second pairing strategy 264.

As discussed above, the analysis module 220 can determine a boundary 330 through the parameter space where the measure of reliability equals the reliability threshold 223 (e.g., p-value equals 0.1). In the example, the boundary 330 is a curve that provides the border for a target region 332 where performance improvement is attributable to the second pairing strategy 264 with the desired level of reliability (e.g., a p-value of 0.1 or less). The target region 332 can span a range of values of the estimated improvement levels 224 and a range of values for incremental performance changes 225. The target region 332 represents a set of operating conditions where it is desirable to operate the CCaaS 170, e.g., a region where the combinations of parameter values provide performance improvement that can be reliably attributed to the second pairing strategy 264.

The map visualization 300 distinguishes the target region 332 where the reliability threshold 223 is met from another region 334 where the reliability threshold 223 is not met. In other words, in the region 334, the p-value is greater than 0.1 and so the performance contribution of the second pairing strategy 264 cannot be distinguished from the results of the first pairing strategy 262 with sufficient reliability.

The map visualization 300 also includes elements that represent the effect of different usage rates 226 on resulting performance and reliability measures. For example, the map visualization 300 shows lines through the parameter space to represent each of various different usage rates 226 of the second pairing strategy 264, e.g., 20% 226a, 40% 226b, 60% 226c, 80% 226d, and 90% 226e. These usage rates 226 represent the proportion of time that the second pairing strategy 264 is on or active, or represent the proportion of contacts assigned using the second pairing strategy 264.

The lines representing the usage rates 226, together with the boundary 330 for the target region 332 demonstrate how the CCaaS 170 can achieve various operating results. For example, if the second pairing strategy 264 provides an estimated gain of 2.0%, then the point on the 20% usage rate line is outside the target region 332 and instead is within region 334, indicating that the reliability measure is insufficient. However, for the same estimated gain of 2.0%, the 40% usage rate line will provide the desired level of reliability. In addition, for the estimated gain of 2.0%, if it is desirable to increase the number of units sold by at least 400, then a usage rate of 60% would provide this increase, while a usage rate of 40% would not and a usage rate of 80% or 90% would not provide the desired level of reliability.

Referring again to FIG. 2, in stage (D), the computer system 210 sends the map visualization 300 and/or the map data 232 to the client device 202 over the network 160. The client device 202 then renders the map data 232 and displays the map visualization 300 on a user interface 204. For example, the map visualization 300 can be presented in a web browser, document viewer, native application, etc. In some implementations, the computer system 210 provides an interface for an authorized user (e.g., an administrator) to request and receive information about the CCaaS 170 over the network using the client device 202. For example, the computer system 210 can provide a web page or web application that includes controls and user interfaces to request and view information such as the map visualization 300. As another example, the computer system 210 can provide an application programming interface (API) that enables the client device 202 to request and receive map data 232 for map visualizations.

In addition to providing the map data 232, the computer system 210 can provide other results from the analysis performed. For example, the computer system 210 can recommend one or more parameter values, such as a usage rate for the second pairing strategy 264, to be applied at the CCaaS 170. The computer system 210 can obtain a value indicating an estimated improvement level of the second pairing strategy 264 over the first pairing strategy 262. Based on the analysis used to generate the map data 232, the computer system 210 can determine one or more usage rates that provide the desired level of reliability at the estimated improvement level. The computer system 210 can also determine and provide the levels of incremental performance changes expected for the selected usage rates. For example, for an estimated gain of 2.0%, the computer system 210 may recommend (1) a usage rate of 40%, having a predicted increase in 240 units sold, and/or (2) a usage rate of 60%, having a predicted increase in 420 units sold.

Using the same principles, the computer system 210 can also receive queries from the client device 202 and can generate and provide the results. For example, the computer system 210 may be configured to process queries that request the minimum usage rate, maximum usage rate, or range of usage rates meets the reliability threshold 233 for a particular level of estimated gain. As another example, the computer system 210 may be configured to process queries that request the minimum estimated gain that can satisfy the reliability threshold 233, or the parameter values that provide certain amounts of performance improvement.

As discussed further below, the map visualization 300 can be provided on a user interface having interactive controls (e.g., input fields, sliders, etc.) for interacting with or adjusting the visualization 300. For example, the controls can enable a user of the client device 202 or the computer system 210 to plot different parameter value combinations on the visualization 300, to indicate whether they fall in or out of the target region 332. Similarly, the controls can permit a user to change parameter values used to perform the analysis (e.g., change the expected volume of contacts, the expected baseline performance level of the first pairing strategy 262, the reliability threshold, etc.). The computer system 210 can update the analysis based on the input received, and can provide an updated map data 232 for a new version of the map visualization 300 that is based on the user-specified parameters.

In stage (E), the user of the client device 202 can specify settings for the CCaaS 170 that adjust how the CCaaS 170 operates. In some examples, a user of the computer system 210 specifies settings for the CCaaS 170 that adjust how the CCaaS 170 operates. For example, based on the information in the map visualization 300, the user of the client device 202 or of the computer system 210 can select a usage rate for the second pairing strategy 264. As an example, the user can select to begin using the second pairing strategy 264 at a usage rate of 40% (e.g., 40% of the time, or 40% of the contacts), while the first pairing strategy 262 is used at a usage rate of 60% (e.g., the remaining 60% of the time, or 60% of the contacts). The pairing settings 250 that the user specifies are provided to the CCaaS 170 over the network 160 from either the client device 202 or the computer system 210. As another example, if the computer system 210 recommends one or more usage rates for the second pairing strategy 264, the user may use the user interface 204 to confirm or approve a recommended usage rate, and the client device 202 or the computer system 210 can transmit the setting to the CCaaS 170 in response.

In stage (F), the CCaaS 170 receives the pairing settings 250 and adjusts operation accordingly. In the example, the CCaaS 170 includes a pairing strategy selector 260 to manage the alternating use of multiple pairing strategies. The pairing strategy selector 260 can use time-based switching (e.g., epoch benchmarking) or switching based on randomization or counting (e.g., inline benchmarking) to cycle between multiple pairing strategies. The pairing strategy selector 260 sets the desired usage rates, e.g., 60% for the first pairing strategy 262 and 40% for the second pairing strategy 264. As a result, the pairing strategy selector 260 continues to operate the two pairing strategies 262, 264 based on the indicated proportions or ratios.

As the CCaaS 170 assigns agents to contacts using these strategies 262, 264, the outcomes resulting from the interactions are tracked, so that the performance of the CCaaS 170 can be measured. These assignments result in the creation of additional interaction data 270, representing the records of contact-agent interactions during periods of time when the CCaaS 170 cycles between the strategies 262, 264. The usage rates for the pairing strategies 262, 264 were set to levels predicted to permit reliable performance attribution, based on the analysis performed by the computer system 210. Therefore, these assignments based on the selected usage rates help to generate high-quality data in which performance improvements can be reliably attributed and the machine learning model 236 itself can be trained, as further discussed herein. For example, the additional interaction data 270 indicates performance results over a period of time. Because the usage rates have been set to operate in conditions in the target region 332 (see FIG. 3A), the performance improvements achieved by using the second pairing strategy 264 over the period of time can be reliably determined and distinguished from the performance of the first pairing strategy 262 over the same period of time.

In some implementations, the second pairing strategy 264 employs a machine learning model 236 to perform pairing of contacts and agents. The machine learning model 236 can be generated or trained initially based on the historical interaction data 214 to learn the characteristics of pairings that lead to high performance (e.g., high sales, low error rates, lower call durations, higher customer satisfaction scores, etc.). The machine learning model 236 can be any appropriate type of model, such as a neural network, a classifier, a decision tree, a support vector machine, and so on.

In the example, the computer system 210 includes a model training module 234 that can generate and train machine learning models to best suit each individual queue of contacts handled by the CCaaS 170. For example, there can be separate queues of contacts for a sales department, technical support, and customer service. For each of the three queues, a separate set of historical interaction data can be extracted and a separate machine learning model trained. To initially generate the machine learning model 236, the model training module 234 may use the pairings and results from the historical interaction data 214 as training data. The model training module 234 may use any appropriate training algorithm such as gradient descent, Newton's method, conjugate gradient, Levenberg-Marquardt algorithm, and so on.

Over time, as more interaction data is available, the computer system 210 can further train the machine learning model 236 so that it can identify pairings that lead to even higher performance of the CCaaS 170. For example, in stage (G), the computer system 210 (or another system) uses the additional interaction data 270 to update and improve the machine learning model 236. Starting with the version of the machine learning model 236 trained based on the historical interaction data 214, the model training module 234 performs further training to update the machine learning model 236 based on the examples of pairings in the additional interaction data 270. This process allows the machine learning model 236 to be improved over time. In addition, as the types of contacts shift and the behavior or preferences of contacts changes, repeated or ongoing training of the machine learning model 236 enables the machine learning model 236 to be updated for new trends and patterns that emerge over time. After the machine learning model 236 is updated, the updated version of the machine learning model 236 is provided to the CCaaS 170, to be used in the second pairing strategy 264.

Over time, as more interaction data becomes available for training the machine learning model 236, the performance of the machine learning model 236 and the pairing strategy 264 often improves. The computer system 210 or an administrator can use this characteristic to plan a series of different operating parameter values to use for the CCaaS 170. For example, a progression of different usage rates can be determined for the second pairing strategy 264, along with conditions or criteria for changing between the usage rates. This can provide a clear path or sequence of milestones specifying when it is appropriate to increase the usage rate of the second pairing strategy 264. For example, a planned progression can specify to initially use a 40% usage rate, then switch to a higher usage rate of 50% once the second pairing strategy 264 is determined to provide at least a 2.5% improvement in performance relative to the first pairing strategy 262. In addition, a third usage rate of 60% may be planned for use once at least a 3.0% improvement is achieved. Each of these combinations of parameters can be selected to maintain conditions to be within the target region 332 where the predetermined level of reliability is provided. Over time, the tracked performance can be used to determine the level of improvement that is actually provided by the second pairing strategy 264. With the calculated improvement level, the plan can be implemented to automatically change the usage rate for the second pairing strategy 264 at the CCaaS 170 (e.g., from 40% to 50% to 60%) when the corresponding level of improvement (e.g., 2.0%, 2.5%, and 3.0%) is reached. This progression allows confidence in the effectiveness of the second pairing strategy 264 to be built up at first, and also allows the overall performance to be improved further as greater levels of improvement and higher usage rates help optimize the performance of the CCaaS 170 in stages.

In the example, of FIG. 2 and FIG. 3A, the measure of performance that is tracked, analyzed, and presented in the map visualization 300 is the number of sales made. The computer system 210 can use the same techniques to perform analysis for, and generate visualizations for, other aspects of performance, e.g., customer satisfaction ratings, customer wait times for call, call duration, etc.

FIGS. 3A-3G show examples of various visualizations that the computer system 210 can generate based on the analysis discussed with respect to FIG. 2.

As discussed above, FIG. 3A shows an example of a map visualization 300 showing how various combinations of parameter values affect performance in terms of units sold. The horizontal axis 310 shows a range of values for the percentage of improvement that the second pairing strategy 264 provides over the first pairing strategy 262. The vertical axis 320 shows a range of values for units sold, as a marginal increase over using the first pairing strategy 262 alone. The boundary 330 defines the target region 332 where conditions permit attribution of performance improvements (e.g., the marginal increases along the vertical axis 320) from use of the second pairing strategy 264 in a manner that satisfies the reliability threshold 223. The predicted results that would be achieved from various usage rates 226 are shown as lines 226a-226e.

FIG. 3B shows an example how the visualization 300 can be used to predict the results of specific operating conditions. For example, if the second pairing strategy 264 is predicted to provide a 2% improvement over the first pairing strategy 262, this represents the range of results shown by the vertical line 340. The intersections of the lines 226a-226e with the vertical line 340 show how different usage rates are predicted to result in different amounts of incremental increases in sales. For example, the line 226b representing a 40% usage rate intersects the line 340 at point 342, which shows that using the second pairing strategy at a 40% usage rate would provide an incremental increase of 300 unit sales over using the first pairing strategy 262 alone.

The locations where the usage rate lines 226a-226e intersect the vertical line 340 also shows whether the different usage rates would provide the desired level of reliability when there is a 2% level of estimated improvement. For example, the point 342 is within the target region 332, indicating that the reliability threshold 223 is satisfied. The intersection of the usage rate line 226c, representing a 60% usage rate, also falls within the target region 332. However, the intersections of the usage rate lines 226a, 226d, 226e fall outside the target region, showing that usage rates of 20%, 80%, and 90% would not satisfy the reliability threshold 223 (e.g., would result in a p-value of greater than 0.1). In other words, for the estimated gain of 2%, the usage rate can be increased from 40% to 60% and still provide a p-value of no more than 0.1, but the usage rate should not be increased to 80%, because statistical significance would be lost and the gains would not be distinguishable from sampling noise.

FIG. 3C shows a map visualization 300C that is based on a different level of performance for the first pairing strategy 262 than is reflected in the visualization 300. The map visualization 300C is based on a performance level, e.g., conversion rate, of 6% for the first pairing strategy 262, instead of a 5% rate as used for the visualization 300. This difference in performance can be set based on, for example, a change in performance measured for the first pairing strategy 262, historical interaction data from a different queue in the contact center, to simulate the effect of a different performance level, or other differences in the contact center state or environment.

The change in performance level used, from 5% to 6%, results in a change in region of the parameter space that will satisfy the reliability threshold 223. For example, based on the analysis of the computer system 210, the target region 332c of acceptable reliability is defined by the border 330c (instead of by the border 330 that defined the target region 332 in the visualization 300). In addition, the scale of the vertical axis 320 has been adjusted to show how increased performance of the first pairing strategy 262 would lead to a different level of incremental increases in units sold. For example, the intersection point 342c (representing a 2% estimated improvement by the second pairing strategy 264 and use of the 40% usage rate) shows an incremental increase of 360 units sold. Due to the change in conversion rate from 5% to 6%, the projected amount of 360 additional units is greater than the 300 additional units that the same 2% estimated improvement and 40% usage rate.

The visualization 300c shows additional results of the changed target region 332c. For example, at the 2% estimated improvement level, the intersection of the 80% usage rate line 226d with the line 340 is within the target region 332c. This shows that using the 80% usage rate is expected to satisfy the reliability threshold 223, even though the 80% usage rate was not expected to satisfy the reliability threshold 223 under the conditions shown in the visualization 300 of FIG. 3B. This shows that, at the 2% estimated improvement, the usage rate of 80% can be used to yield of 720 additional units and still satisfy the reliability threshold.

In general, as shown by the examples in FIGS. 3B and 3C, the analysis of the computer system 210, as reflected in the generated visualizations 300, 300c, can reveal the conditions that the CCaaS 170 can operate in under different circumstances and with different expectations or estimates about the CCaaS 170 and the pairing strategies 262, 264. The computer system 210 can perform analysis for, and generate visualizations for, different volumes of contacts (e.g., 500,000 contacts, 600,000 contacts, etc.) in addition to or instead of different estimates of performance (e.g., conversion rate) for the first pairing strategy 262.

FIG. 3D shows an example of the map visualization 300 with a plan or roadmap 350 for setting a series of operating parameters for the CCaaS 170. The analysis of the computer system 210 can reveal how usage rates can be set to increase overall performance, e.g., progressively increase the number of additional units sold, while remaining within the target region 332 where the reliability threshold 223 is satisfied. The map visualization 300 shows that various operating points remain in the target region 332, and the positions along the vertical axis 320 show the amounts of additional units that are expected to be result from operation at those points.

In further detail, the roadmap 350 shows a series of parameter values that are shown with corresponding points 361-364 on the visualization 300. The roadmap 350 shows that, as the performance of the second pairing strategy 264 improves over time (e.g., due to refinement based on collected data, further machine learning training, as otherwise discussed herein, etc.), the usage rate is increased.

As represented by point 360, the roadmap 350 indicates that expected improvement for the second pairing strategy 264 is 2% and that a usage rate of 40% should be used. The roadmap 350 indicates that the usage rate 40% should continue to be used until the second pairing strategy 264 can provide an improvement of 2.5% (represented by point 361), and in response the usage rate should be increased to 80% (represented by point 362). The roadmap 350 indicates that the CCaaS 170 should continue to operate with an 80% usage rate for the second pairing strategy 264 until the estimated improvement reaches 3.0% (represented by point 363), and then the usage rate should be increased to 90% (represented by point 364). This sequence of usage rates provides increasing levels performance, indicated by an increasing amount of additional units along the progression from point 360 to point 364. In this process, the operation of the CCaaS 170 remains in the target region 332 in which the reliability threshold 223 for performance attribution is expected to be satisfied.

FIG. 3D shows an exemplary roadmap 350. A variety of other viable roadmaps may be determined based on the target region 332 and the region 334 where the reliability threshold 223 is not met (not shown), as would be readily determined by one skilled in the art.

In some implementations, the computer system 210 can determine a roadmap or series of operating parameters to be used, with corresponding conditions or criteria for making changes to parameters such as usage rates. The operating points selected can be limited by constraints or preferences specified by a user, such as a preference to limit a number of times the usage rate changes (e.g., no more than 5 changes, no more than 3 changes, etc.), a constraint to reach a minimum level of additional units predicted for the beginning of the sequence, a constraint to reach at least a target level by the end of the sequence (or at another point in the sequence), and so on.

Once a roadmap 350 has been defined, whether by the computer system 210 or by entry from an administrator at the client device 202, the CCaaS 170 or a connected system (such as the computer system 210) can assess performance results achieved and change operation of the CCaaS 170 in response. For example, after the CCaaS 170 has been operated with the second pairing strategy 264 at the 40% usage level (as represented by point 360), the actual performance improvement achieved can be periodically calculated. When the performance results indicate a gain of 2.5% or higher, the usage rate for the second pairing strategy 264 can be automatically adjusted from 40% to 80%. In other words, the CCaaS 170 or another system can detect when operation of the CCaaS 170 reaches the condition represented by point 361, and the settings of the CCaaS 170 are adjusted to operate at the condition represented by the point 362. Because the operation of the CCaaS 170 at the 40% usage rate provides the desired level of reliability, the performance gains due to use of the second pairing strategy 264 can be reliably quantified and attributed to the use of the second pairing strategy 264, and there is a high confidence to justify the increased use of the second pairing strategy 264. In a similar manner, other conditions or criteria of a roadmap can be checked (e.g., a threshold improvement level, a threshold amount of additional units, etc.) and used to trigger changes to the usage rates applied or other operating characteristics of the CCaaS 170.

FIG. 3E shows another example of the map visualization 300, with an additional vertical axis scale 370 overlaid to show an additional measure of performance. In addition to showing additional units on the vertical axis, one or more other measures of performance can be correlated with the amount of additional units and presented in the visualization. In the example, the scale 370 shows revenue, in thousands of dollars, corresponding to different levels of additional units. In the example, there is a fixed or linear correspondence of units to revenue. However, the scale 370 may show non-linear relationships, such as step functions or different tiers in which there may be, for example, increasing revenue for increasing amounts of improvement in the quantity of units (e.g., in some cases, the revenue per unit for 0 -100 additional units may be less than the revenue per unit for 101-200 units).

By representing additional derived attributes or additional outcome types in the map visualization 300, the system can show a user the points in the parameter space that can provide the desired attributes or outcomes. For example, with the revenue scale 370 correlated with the units scale of vertical axis 320, the map visualization 300 shows the combinations of parameter values that can achieve a specific revenue result. For example, the points along the horizontal line 371 show the conditions in which revenue of $100,000 can be achieved. The portions of the line 371 in the target region 332 show the combinations of expected improvement percentage values (along the horizontal axis 310) and usage rates (at lines 226a-226e) that can achieve this revenue result.

FIG. 3F shows another example of a map visualization 300F. The example shows how the computer system 210 can perform analysis to determine the combinations of parameter values that can achieve certain performance targets while satisfying the reliability threshold 223, and how the map visualization 300F can be generated to present those results.

In some cases, the computer system 210 provides an interface for a user to input a target value for a measure of performance to be achieved by the CCaaS 170. For example, the user has specified a target 380 of 400 additional units. The computer system 210 can then determine the combinations of parameter values (e.g., estimated improvement amounts and usage rates) that can provide the indicated target amount of additional units, while also remaining in a target region 332f where the reliability threshold 223 is satisfied. For example, the computer system 210 provides a table 381 showing the levels of estimated improvement needed to reach the target at each of different usage rates (e.g., for a usage rate of 30%, the second pairing strategy 264 needs to provide a 3.56% improvement over the first pairing strategy 262; for a usage rate of 40%, a 2.67% usage rate is needed). The operating conditions represented in the table can be reflected in the table as points of intersection of usage rate lines with a target line 382 representing the target that is set.

With the target analysis, the computer system 210 can solve for conditions that satisfy various user-entered constraints as well as the reliability threshold 223. The computer system 210 can focus the map visualization 300F on the identified region(s) in the parameter space that can achieve the target performance result.

When the analysis indicates levels of estimated improvement of the second pairing strategy 264, this can provide a reference for whether achieving the target is feasible.

FIG. 3G shows another example of a map visualization 300G, in which the improvement in performance is a decrease in the number of undesired outcomes.

The horizontal axis 390 indicates improvement of the second pairing strategy 264.

The vertical axis 391 indicates a number of unnecessary on-site service visits, e.g., a change in the number of unnecessary service visits compared to what would be expected for use of the first pairing strategy 262 alone. In general, it is undesirable and costly to dispatch a technician to a location if an on-site visit is not needed to resolve the problem. As a result, reducing the number of unnecessary visits made is a valuable improvement in performance of a call center system. This is reflected in the map visualization 300G showing greater decreases in the number of unnecessary service visits representing increased performance.

As with other visualizations discussed above, the map visualization 300G has a border 330g that specifies the limit to a target region 332g, which represents conditions in which cycling between the two pairing strategies 262, 264 is predicted to satisfy the reliability threshold 223. In the example, the user specified an indication of a parameter combination to test, an estimated improvement of 2.0% and a usage rate of 50%. The computer system 210 indicates this combination of parameters with the point 395, which falls within the region 334g where the desired level of performance attribution reliability is not met, thus falling outside the target region 332g that would provide the desired level of performance attribution reliability. The computer system 210 shows the predicted results that would be achieved by this user-specified combination of parameters, including a reduction of unnecessary service visits by 229 and a p-value of 0.125. Other points 396, 397 have been selected by the user, and, as a result, information about the predicted effects of using these combinations of parameter values is displayed.

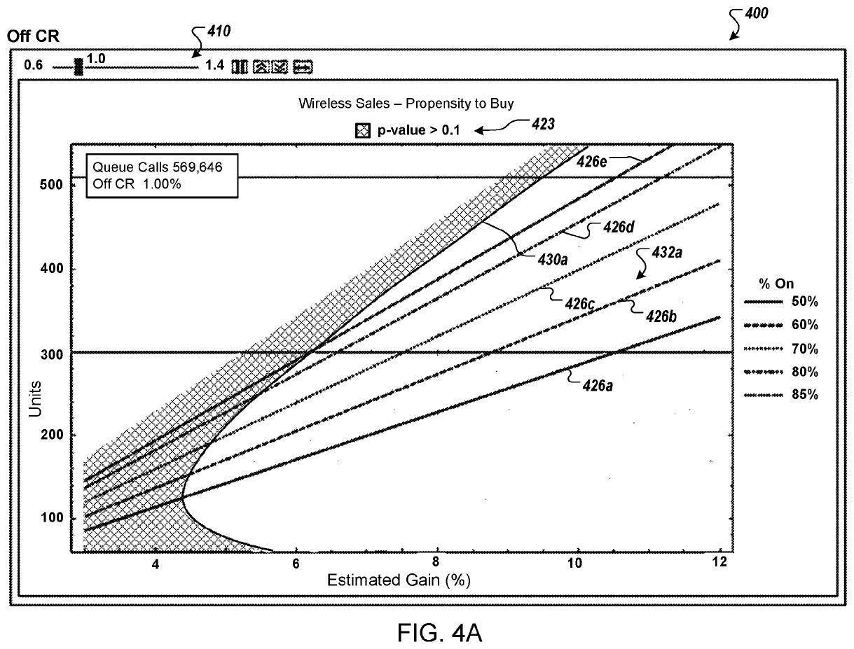

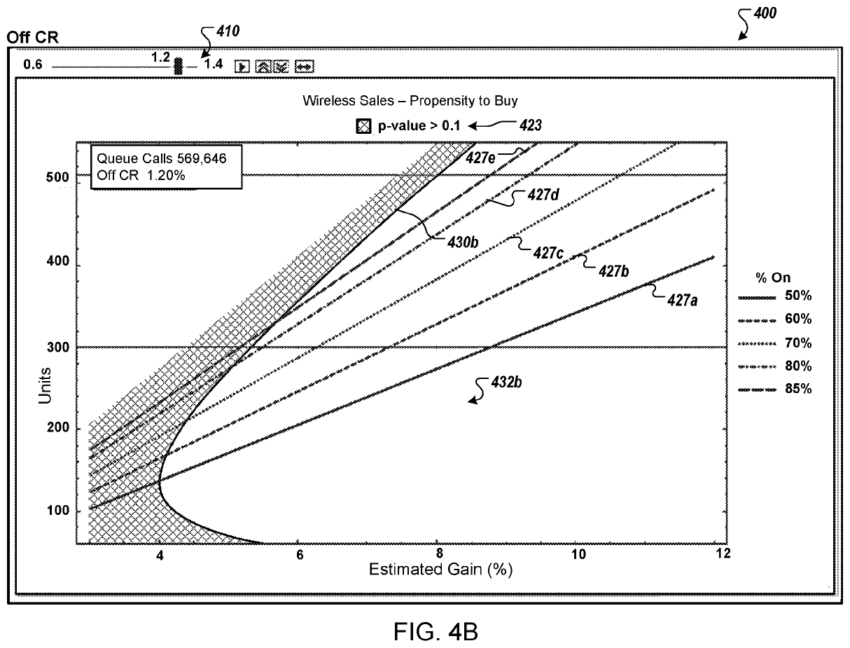

FIGS. 4A and 4B show an example of a map visualization 400 that is interactive to allow users to change characteristics of the analysis performed. The map visualization 400 can be provided through a web page, web application, or other interactive user interface. The map visualization 400 has one or more associated interactive controls for adjusting one of the parameters used to generate the map visualization. For example, a control 410 provides a user the capability to adjust the performance level expected for the first pairing strategy 262. The map visualization 400 is then automatically updated in response to user input that changes the performance level setting. This permits a user to simulate or explore the effects of different values that the computer system 210 uses to perform its analysis. The user receives updated visualization data showing the changed set of parameter value combinations in the parameter space that will meet the reliability threshold 223, e.g., by a change in the size, shape, and/or position of the target region of acceptable reliability.

In FIG. 4A, the control 410 is set so that the estimated performance of the first pairing strategy 262 is a conversion rate of 1.0% (e.g., the “Off CR,” representing performance when the first pairing strategy 262 is used and the second pairing strategy 264 is not used). This setting results in a border 430a along a path where reliability is equal to the threshold value (e.g., a curve where the p-value equals 0.1). The border 430a defines a target region 432a where the combinations of values for expected improvement of the second pairing strategy 264 and values for additional units sold satisfy the reliability threshold 423. Various usage rate lines 426a-426e show the conditions that can be achieved for different usage rates of the second pairing strategy 264.

From the view of the map visualization 400 shown in FIG. 4A, the user interacts with the control 410 to change the conversion rate from 1.0% to 1.2%, which triggers an update to the map visualization 400 as shown in FIG. 4B. The change in conversion rate changes the target region 432a, the border 430a, and the usage rate lines 426a-426e. As a result, FIG. 4B shows a new target region 432b, border 430b, and usage rate lines 427a-427e. For example, the usage rate line 427a and the target region 432b show that, with the 1.2% conversion rate, a 50% usage rate can provide the desired level of reliability at an estimated improvement of 4.0%, compared to about 4.5% when there is a 1.0% conversion rate.

To respond to user inputs to the control 410 and other user interface controls, the client device 202 can provide user input to the computer system 210 over the network 160. The computer system 210 can perform the updated analysis and generate updated map data based on the new parameter value(s) that the user specified. The computer system 210 can then return the updated map data to the client device 202 over the network 160, where the updated map data can be rendered to display the updated map visualization 400.

In some implementations, rather than rely on the client-server interactions, the initial map data that the computer system 210 provides can include associated code, scripts, or functions that enable the client device 202 to calculate the effects of changed parameters specified through interactive controls. For example, a web page, web application, or other interactive document can include script content or interpretable or executable code that runs in a web browser and which re-calculates the content of the visualization 400 as a user changes parameter values.

In some implementations, the user inputs to the control 410 and/or other user interface controls may be provided directly to the computer system 210.

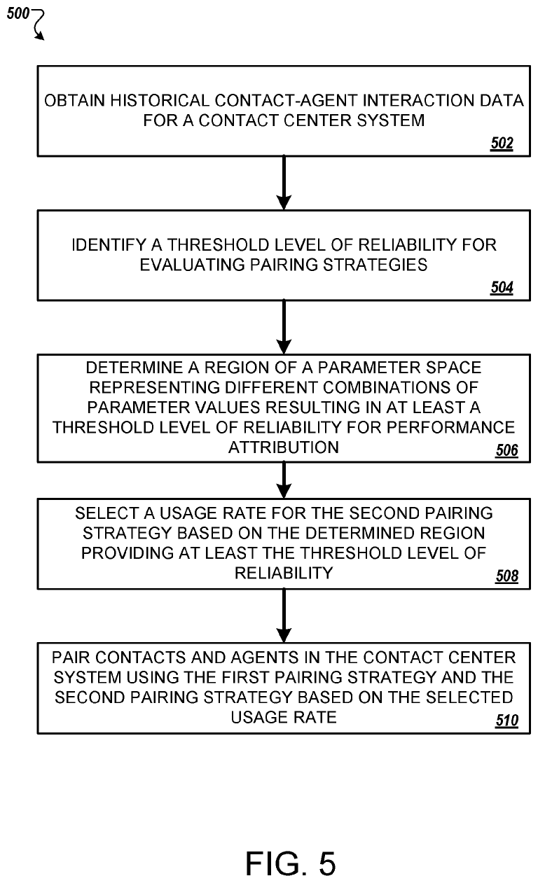

FIG. 5 is a flow diagram that shows an example of a process 500 for assessing and improving contact center performance. The process 500 can be performed by one or more computers, such as the computer system 210, the client device 202, or another appropriate computing device.

The process 500 includes obtaining historical contact-agent interaction data for a contact center system (502). The historical contact-agent interaction data can indicate performance of the contact center system using a first pairing strategy.

The process 500 includes identifying a threshold level of reliability for evaluating pairing strategies for the contact center system (504). For example, the threshold level of reliability can be a threshold value for a reliability metric such as a level of statistical significance (e.g., a p-value). The level of reliability can be a reliability for attributing performance improvements among multiple pairing strategies, based on a data set describing results of alternating or cycling use of the multiple pairing strategies over a time period.

The process 500 includes determining a region of a parameter space representing different combinations of parameter values for the contact center system (506). For example, based on the historical contact-agent interaction data, the computer system 210 can determine a region that spans ranges of values for each of multiple parameters. The determined region indicates combinations of parameter values that allow reliable performance attribution for performance improvements resulting from use of a second pairing strategy in combination with the first pairing strategy. For example, the determined region can be a target region in which performance improvements are identifiable as resulting from use of the second pairing strategy with at least the threshold level of reliability. In other words, the determined region can define conditions in which performance improvements of using the second pairing strategy can be attributed with at least a minimum level of confidence or statistical significance. In some implementations, the parameter space is a two-dimensional space representing different conditions that can occur in the contact center system, based on expected properties of contacts at the contact center system (e.g., contact volume) based on historical characteristics of the contacts at the contact center system.

To determine a target region of the parameter space, the computer system 210 can define a boundary of the region in the parameter space. The boundary can be defined by combinations of parameter values that provide reliability at the threshold level. The boundary defines the region and separates the region from other regions of the parameter space that represent combinations of parameter values that do not provide the threshold level of reliability for identifying performance improvements. The boundary can be a curve or edge in the parameter space that defines the target region where operation of the contact center system will provide statistically significant performance attribution.

The parameter space can include a range of parameter values for a first parameter representing a level of estimated improvement of the second pairing strategy compared to the first pairing strategy. For example, the first parameter can be a level of estimated improvement that the second pairing strategy provides relative to the first pairing strategy (e.g., an estimated percentage improvement, as in FIG. 3A). The parameter space can also include a range of parameter values for a second parameter quantifying incremental changes in outcomes at the contact center system resulting from use of the second pairing strategy in combination with the first pairing strategy. For example, the second parameter can be an incremental amount of desirable outcomes achieved (e.g., additional units sold, as in FIG. 3A), an incremental amount of undesirable outcomes avoided (e.g., amount of unnecessary service calls avoided, as in FIG. 3E), or measures of other metrics (e.g., customer satisfaction ratings, transaction value, call duration, customer wait times before reaching an agent, etc.).

The process 500 includes selecting a usage rate for the second pairing strategy (508). The usage rate is selected based on the determined region in which performance improvements are identifiable with at least the threshold level of reliability as resulting from use of the second pairing strategy.

The process 500 includes pairing contacts and agents in the contact center system using the first pairing strategy and the second pairing strategy based on the selected usage rate (510). For example, a usage rate of the second pairing strategy in the contact center system is based on the selected usage rate. The contact center system is operated to cycle between use of the first pairing strategy and the second pairing strategy, with the proportion of time or contacts handled by the second pairing strategy set based on the selected usage rate. As a result, the contact center system can be operated under conditions that are most likely to both (i) improve performance over use of the first pairing strategy alone, and (ii) provide a record of outcomes that enables those improvements to be attributed to use of the second pairing strategy.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment.

Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

What is claimed is:

1. A method performed by one or more computers, the method comprising:
obtaining, by the one or more computers, historical contact-agent interaction data for a contact center system, wherein the historical contact-agent interaction data indicates performance of the contact center system using a first pairing strategy;
identifying, by the one or more computers, a threshold level of reliability for evaluating pairing strategies for the contact center system;
based on the historical contact-agent interaction data, determining, by the one or more computers, a region of a parameter space representing different combinations of parameter values for the contact center system, wherein the region spans ranges of values for each of multiple parameters and the region indicates combinations of parameter values for which performance improvements resulting from use of a second pairing strategy in combination with the first pairing strategy are identifiable with at least the threshold level of reliability as resulting from use of the second pairing strategy;
selecting, by the one or more computers, a usage rate for the second pairing strategy, wherein the usage rate is selected based on the determined region in which performance improvements are identifiable with at least the threshold level of reliability as resulting from use of the second pairing strategy; and
pairing, by the one or more computers, contacts and agents in the contact center system using the first pairing strategy and the second pairing strategy, wherein a usage rate of the second pairing strategy in the contact center system is based on the selected usage rate.

2. The method of claim 1, wherein determining the region of the parameter space comprises defining a boundary of the region in the parameter space, wherein the boundary is defined by combinations of parameter values that provide the threshold level of reliability for identifying performance improvements and the boundary separates the region from regions of the parameter space representing combinations of parameter values that do not provide the threshold level of reliability for identifying performance improvements.

3. The method of claim 1, wherein determining the region comprises defining a curve in the parameter space that bounds the region at combinations of parameters that provide the threshold level of reliability for identifying performance improvements.

4. The method of claim 1, wherein the parameter space includes a range of parameter values for each of (i) a first parameter representing a level of estimated improvement of the second pairing strategy compared to the first pairing strategy and (ii) a second parameter quantifying incremental changes in outcomes at the contact center system resulting from use of the second pairing strategy in combination with the first pairing strategy.

5. The method of claim 1, wherein determining the region of the parameter space comprises determining the region based on (i) a volume of contacts at the contact center system determined from the historical contact-agent interaction data and (ii) a measure of performance of the contact center system achieved when using the first pairing strategy.

6. The method of claim 1, further comprising identifying portions of the determined region that respectively correspond to different usage rates for using the second pairing strategy.

7. The method of claim 1, further comprising determining an estimated level of performance improvement that the second pairing strategy provides compared to the first pairing strategy;
wherein selecting the usage rate for the second pairing strategy comprises selecting, from among multiple different usage rates, a usage rate that with the estimated level of performance improvement results in a combination of parameter values in the determined region.

8. The method of claim 1, wherein the performance of the contact center system comprises an amount or rate that a predetermined outcome occurs for contacts at the contact center system, and wherein the performance improvements include an increase in the amount or rate at which the predetermined outcome occurs at the contact center system.

9. The method of claim 1, further comprising identifying a series of usage rates to apply for different estimated levels of improvement provided by the second pairing strategy compared to the first pairing strategy, wherein the series of usage rates and estimated levels of improvement provide progressively higher performance of the contact center system while remaining within the determined region in which performance improvements from the second pairing strategy are identifiable with at least the threshold level of reliability.

10. The method of claim 1, further comprising providing user interface data for a visualization that distinguishes the determined region from regions of the parameter space that do not provide the threshold level of reliability for identifying performance improvements.

11. The method of claim 10, wherein the visualization indicates combinations of parameter values in the region that correspond to different usage rates of the second pairing strategy when used in combination with the first pairing strategy.

12. The method of claim 11, wherein the visualization indicates measures of performance of the contact center system for each of multiple different aspects of performance, wherein the measures of performance are correlated so that the visualization indicate the expected measure of performance that would be achieved in the target region for each of the different aspects of performance.

13. The method of claim 1, wherein selecting the usage rate for the second pairing strategy comprises selecting a usage rate that provides, for an estimated level of performance improvement that the second pairing strategy provides relative to the first pairing strategy, at least a minimum margin from a boundary of the determined region at which the threshold level of reliability is provided.

14. The method of claim 1, wherein the second pairing strategy involves using a machine learning model to perform pairing of contacts and agents.

15. One or more non-transitory computer-readable media storing instructions that are operable, when executed by one or more computers, to cause the one or more computers to perform the method of claim 1.

16. A system comprising:
one or more computers; and
one or more computer-readable media storing instructions that are operable, when executed by the one or more computers, to cause the one or more computers to perform a method comprising:
obtaining, by the one or more computers, historical contact-agent interaction data for a contact center system, wherein the historical contact-agent interaction data indicates performance of the contact center system using a first pairing strategy;
identifying, by the one or more computers, a threshold level of reliability for evaluating pairing strategies for the contact center system;
based on the historical contact-agent interaction data, determining, by the one or more computers, a region of a parameter space representing different combinations of parameter values for the contact center system, wherein the region spans ranges of values for each of multiple parameters and the region indicates combinations of parameter values for which performance improvements resulting from use of a second pairing strategy in combination with the first pairing strategy are identifiable with at least the threshold level of reliability as resulting from use of the second pairing strategy;
selecting, by the one or more computers, a usage rate for the second pairing strategy, wherein the usage rate is selected based on the determined region in which performance improvements are identifiable with at least the threshold level of reliability as resulting from use of the second pairing strategy; and
pairing, by the one or more computers, contacts and agents in the contact center system using the first pairing strategy and the second pairing strategy, wherein a usage rate of the second pairing strategy in the contact center system is based on the selected usage rate.

17. The system of claim 16, wherein determining the region of the parameter space comprises defining a boundary of the region in the parameter space, wherein the boundary is defined by combinations of parameter values that provide the threshold level of reliability for identifying performance improvements and the boundary separates the region from regions of the parameter space representing combinations of parameter values that do not provide the threshold level of reliability for identifying performance improvements.

18. The system of claim 16, wherein determining the region comprises defining a curve in the parameter space that bounds the region at combinations of parameters that provide the threshold level of reliability for identifying performance improvements.

19. The system of claim 16, wherein the parameter space includes a range of parameter values for each of (i) a first parameter representing a level of estimated improvement of the second pairing strategy compared to the first pairing strategy and (ii) a second parameter quantifying incremental changes in outcomes at the contact center system resulting from use of the second pairing strategy in combination with the first pairing strategy.

20. The system of claim 16, wherein determining the region of the parameter space comprises determining the region based on (i) a volume of contacts at the contact center system determined from the historical contact-agent interaction data and (ii) a measure of performance of the contact center system achieved when using the first pairing strategy.
